(19) United States
(12) Patent Application Publication
(10) Pub. No.: US 2024/0349746 A1
(43) Pub. Date: Oct. 24, 2024

(54) METHODS AND COMPOSITIONS COMPRISING CAFFEINE AND/OR A DERIVATIVE THEREOF AND A POLYPHENOL

(71) Applicant: THE COCA-COLA COMPANY, Atlanta, GA (US)

(72) Inventors: Cynthia FRANCIS, Atlanta, GA (US); Haiyu REN, Atlanta, GA (US); Brenda RUDAN, Atlanta, GA (US); Raymond W. SCHACHT, Atlanta, GA (US); Bin WANG, Atlanta, GA (US)

(21) Appl. No.: 18/688,328

(22) PCT Filed: Sep. 1, 2022
(86) PCT No.: PCT/US2022/075854

§ 371 Date: Feb. 29, 2024

Related U.S. Application Data
(60) Provisional application No. 63/239,743, filed on Sep. 1, 2021.

(51) Int. Cl. A23F 5/24; A23F 5/44; A23L 27/30; A23L 29/00; A23L 33/105

(52) U.S. Cl. CPC A23F 5/24; A23F 5/44; A23L 27/30; A23L 29/03; A23L 33/105

(57) ABSTRACT

The present disclosure presents compositions and methods for improving cognitive function and/or alertness of a human. In one embodiment, a method comprises: administering to the human in need of an improved condition an edible composition, wherein the composition comprises: caffeine and/or a derivative thereof; and a polyphenol, wherein the composition has a weight ratio of the total polyphenol to the total caffeine from about 1:10 to about 10:1. In some embodiments, the polyphenol is a chlorogenic acid (CGA).

This application is being filed on Sep. 1, 2022, as a PCT International Patent application and claims the benefit of and priority to U.S. Provisional patent application Ser. No. 63/239,743, filed Sep. 1, 2021, the entire disclosure of which is incorporated by reference herein in its entirety.

### INTRODUCTION

The present disclosure generally relates to edible compositions, beverages, and methods for improving a condition or function or performance of a human.

Coffee is one of the most popular beverages worldwide. As a source used for its caffeine content, coffee is generally known for its stimulatory effects on behavior. Caffeine has been generally known to increase alertness and improve the performance of attention tasks. However, coffee is not only a source of caffeine but is also rich in many natural components, including polyphenols such as chlorogenic acids (CGA), caffeic acid, and ferulic acid. Phenolic acids including chlorogenic acids are an important and biologically active compounds, playing several important and therapeutic roles such as antioxidant activity, antibacterial, hepatoprotective, cardioprotective, anti-inflammatory, antipyretic, neuroprotective, anti-obesity, antiviral, anti-microbial, anti-hypertension, free radicals scavenger, and a central nervous system stimulator.

Compositions and beverages comprising chlorogenic acids have been disclosed. For example, WO2012/062928 discloses methods of improving mental or physical health conditions by administering to an individual in need of an improved mental or physical health condition a decaffeinated coffee product comprising an unroasted coffee and is substantially free from caffeine.

WO2005/072533 discloses a coffee composition comprising the following components (A) and (B): from 0.01 to 1 wt. % of (A) chlorogenic acids, less than 0.1 wt. %, based on the amount of the chlorogenic acids, of (B) hydroxyhydroquinone.

WO2006/108578 discloses a coffee product comprising (i) a first portion consisting of unroasted coffee, and (ii) a second portion consisting of ground coffee which has been roasted to a higher degree of roast than said first portion, and the coffee product comprises at least 4 g of chlorogenic acids per 100 g of product.

WO2013/052208 discloses whole green coffee bean products and methods of production and use for focus and concentration. The whole green coffee beans may comprise Coffea robusta coffee beans, and the phytonutrients may include chlorogenic acid.

WO2013/103465 discloses an edible composition comprising an extract of an edible substance, and the edible substance may also be, in whole or in part, at least one of green coffee cherries. The edible composition may comprise polyphenols including chlorogenic acid.

US20190159474 discloses a method of extracting whole coffee fruit, an extract obtained from the method, and method of ameliorating age-related neurodegenerative diseases using said extract. The whole coffee fruit extract may comprise chlorogenic acid (CA) and procyanidine.

However controversies remain on the contribution of polyphenols or phenolic acids to the improvement of cognitive functions.

Cropley et al. reported that decaffeinated coffee high in chlorogenic acid improved some mood and behavioral measures for healthy elderly, relative to regular decaffeinated coffee. (Cropley, 2011). Similarly, Haskell-Ramsay et al. attributed the increased alertness and decreased negative emotional processing to CGA in a comparative study of CGA-containing decaffeinated coffee versus regular coffee. Moreover, Jackson et al. reported that the addition of phenolics anthocyanins, flavanols, and phenolic acids to a botanical drink containing potentially bioactive beetroot, sage and ginseng would lead to differential patterns of modulation of cognitive function, mood and CBF parameters. (Jackson, 2020). Ward-Ritacco et al. reported that moderate doses of caffeine combined with apple extract are effective at improving cognitive outcomes, especially serial seven subtraction, and mood responses to the tasks, including alertness and mental and physical fatigue. (Ward-Ritacco, 2020).

In contrast, a series of recent publications cast doubts on the effectiveness of CGAs. For example, Camfield et al. suggested that any improvements in cognitive function that were found to be associated with decaffeinated green blend coffee are most likely not attributable to the CGAs. (Camfield, 2013). Similarly, Reed et al. reported a study on the influence of acute consumption of a polyphenol-rich, non-caffeinated coffeeberry extract on performance of a series of fatiguing cognitive tasks. (Reed, 2019). Reed et al. concluded from the results that the coffeeberry extract beverages had no effect on self-reported motivation to complete the cognitive tasks or either working memory or sustained attention performance. (Reed, 2019). More recently, McGranahan et al. reported that consumption of a beverage with 100 mg or 300 mg coffeeberry extract one hour before a cognitive test or two hours before a high intensity exercise bout does not influence feelings of alertness, energy, and fatigue or cycling performance. (McGranahan, 2021).

In spite of the above disclosures, it is still desired for new compositions and beverages that further improve cognitive functions and/or alertness compared to conventional caffeinated products or decaffeinated products. It is also desired for methods of improving cognitive functions and/or alertness with compositions or beverages for certain subject pools in need thereof. It is further desired for methods for improving cognitive functions and/or alertness using compositions or beverages that have identified ingredients and optimized contents thereof.

### SUMMARY OF THE INVENTION

The present disclosure presents compositions, beverages, and methods that meet the above stated needs.

In some aspects, the present disclosure relates to an edible composition, comprising: caffeine and/or a derivative thereof; and a polyphenol comprising a chlorogenic acid, wherein the composition has a weight ratio of the total polyphenol to the total caffeine from about 1:10 to about 10:1. In some embodiments, the edible composition is a manufactured food product.

In some embodiments, the polyphenol of the present composition is selected from the group of flavonoids, flavanols, flavones, isoflavones, flavanones, anthocyanins, phenolic acids, catechins, proanthocyanidins, procyanidins, quercerin, rutin, reservatrol, isoflavones, punicalagin, ellagitannin, hesperidin, naringin, citrus flavonoids, lignans, curcuminoids, stilbenes, an oligomeric/polymeric form thereof, or any combinations thereof.

In some embodiments, the polyphenol of the present composition comprises a chlorogenic acid. Non-limiting examples of the chlorogenic acid include caffeoylquinic acids, dicaffeoylquinic acids, feruloylquinic acids, cumaroylquinic acids, or a derivative thereof, or any combinations thereof. In certain embodiments, the present composition has a weight ratio of the total chlorogenic acid to the total caffeine from about 1:10 to about 10:1. In some embodiments, the edible composition is a manufactured food product. In a particular embodiment, the weight ratio of the total chlorogenic acid to the total caffeine is from about 1.5:1 to about 3:1.

In some embodiments, the present composition further comprises a sweetener. Examples of the sweetener include but are not limited to stevia and steviol glycosides, Luo Han Guo and the related mogroside compounds, monatin and its salts (monatin SS, RR, RS, SR), curculin, glycyrrhizic acid and its salts, thaumatin, monellin, mabinlin, brazzein, hemandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I, sugar alcohols such as erythritol, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs), and combinations thereof.

In some embodiments, the present composition further comprises at least one additive and/or at least one functional ingredient.

In some embodiments, the present composition is in a drinkable liquid form, a concentrate form, a dry form, or a semi-dry form. In some embodiments, the present composition is a gum, gel, tablet, capsule, granule, cubic, or dry powder.

In some embodiments, the present composition is a beverage selected from the group of non-carbonated beverage, carbonated beverage, juice beverage, fruit juice, coffee beverage, tea beverage, milk beverage, diary beverage, plant protein drink, plant-based beverage, sport drink, energy drink.

In some embodiments, the present composition has a Brix value of about 3° to about 25°, or about 5° to about 20°, or about 7° to about 15°.

In some embodiments, the present composition comprises a coffee product selected from the group of: coffee extract, concentrated coffee, dried coffee, soluble coffee, coffee oils, coffee aromas, dry green coffee extract, wet green coffee extract, pulverized coffee, ground coffee, roast coffee, roast and ground coffee, soluble coffee, or any combinations thereof.

In some embodiments, the present composition comprises a tea product selected from the group of: soluble tea product, tea extract, concentrated tea, dried tea, tea leaves, tea aromas, green tea extract, concentrated green tea extract, or any combinations thereof.

In some embodiments, the present composition comprises a coffee berry juice, or a coffee berry extract, or a product of coffee berry, or any combinations thereof. The coffee berry juice and/or the coffee berry extract may be derived from a whole coffee berry. In some embodiments, the coffee berry juice is a non-concentrate coffee berry juice or alternatively a from-concentrate coffee berry juice. The coffee berry may be from Coffea arabica or derivative thereof, Coffea canephora or derivative thereof, or any combination thereof.

In some embodiments, the present composition has a total content of caffeine from about 0.01 wt % to about 2 wt %, or from about 0.05 wt % to about 1 wt %, or from about 0.1 wt % to about 0.5 wt %, or from about 0.1 wt % to about 0.5 wt %, or from about 0.1 wt % to about 0.4 wt %, or from about 0.1 wt % to about 0.3 wt %, or from about 0.1 wt % to about 0.2 wt %.

In some embodiments, the present composition has a dosage of caffeine from about 10 mg to about 500 mg, or from about 20 mg to about 400 mg, or from about 30 mg to about 300 mg, from about 40 mg to about 200 mg, from about 50 mg to about 180 mg, from about 60 mg to about 160 mg, from about 70 mg to about 140, from about 80 mg to about 120 mg, or from about 90 mg to about 100 mg for one serving. In some embodiments, the present composition has a dosage of caffeine of at least 25 mg, at least 50 mg, at least 75 mg, at least 100 mg, at least 125 mg, at least 150 mg, at least 175 mg, at least 200 mg, at least 250 mg, at least 300 mg, at least 350 mg, or at least 400 mg, for one serving.

In some embodiments, the present composition has a total content of polyphenol from about 0.01 wt % to about 2 wt %, or from about 0.05 wt % to about 1 wt %, or from about 0.1 wt % to about 0.5 wt %. In some embodiments, the present composition has dosage of polyphenol from 15 mg to about 300 mg, or from about 30 mg to about 200 mg, or from about 45 mg to about 150 mg for one serving.

In some embodiments, the present composition has a weight ratio of the total polyphenol to the total caffeine is from about 1:8 to about 8:1, or from about 1:6 to about 6:1, or from about 1:4 to about 4:1, or from about 1:2 to about 2:1, or from about 1.5:1 to about 3:1.

In some embodiments, the caffeine and/or the polyphenol is derived from a natural resource, wherein the natural resource is a plant selected from the group of coffee, tea, yerba mate, guayusa, yaupon, guarana, cocoa, kola, or any combination thereof.

In some embodiments, the present composition further comprises a terpene or a derivative thereof. In some embodiments, the present composition has a content of total terpenes from about 0.01 wt % to about 5 wt %, or from about 0.05 wt % to about 4 wt %, or from about 0.1 wt % to about 3 wt %, or from about 0.5 wt % to about 2 wt %, or from about 1 wt % to about 1.5 wt %. In some embodiments, the present composition has a dosage of total terpenes from about 10 mg to about 1,000 mg, or from about 20 mg to about 800 mg, or from about 30 mg to about 600 mg, from about 40 mg to about 500 mg, from about 50 mg to about 400 mg, from about 60 mg to about 300 mg, from about 70 mg to about 250, from about 80 mg to about 200 mg, or from about 90 mg to about 150 mg for one serving.

In some embodiments, the composition comprises a coffee berry extract or a coffee berry juice, and the polyphenol and/or the caffeine are all or substantially from the coffee berry extract or the coffee berry juice. In other embodiments, at least a portion of the polyphenol and/or at least a portion of the caffeine is not from the extract of coffee nor the coffee berry juice.

In some aspects, the present disclosure relates to a beverage comprising: caffeine and/or a derivative thereof; and a polyphenol comprising a chlorogenic acid and/or a derivative thereof, wherein the beverage has a weight ratio of the total chlorogenic acid to the total caffeine from about 1:10 to about 10:1. In some embodiments, the caffeine and/or the polyphenol is derived from coffee berry, or a part, product, extract, or juice thereof.

In some embodiments, the beverage comprises a coffee berry juice or a coffee berry extract, and the coffee berry juice or extract has a weight ratio of the chlorogenic acid to the caffeine from about 1:10 to about 10:1. In some embodiments, the beverage consists essentially of the coffee berry juice or the coffee berry extract.

In some aspects, the present disclosure relates to a beverage consisting of a coffee berry juice, the coffee berry juice comprising: from about 0.01 wt % to about 2 wt % of caffeine; and from about 0.01 wt % to about 2 wt % of a polyphenol, wherein the polyphenol is chlorogenic acid, wherein the coffee berry juice has a weight ratio of the chlorogenic acid to the caffeine from about 1:10 to about 10:1, or from about 1:8 to about 8:1, or from about 1:6 to about 6:1, or from about 1:4 to about 4:1, or from about 1:2 to about 2:1, or from about 1.5:1 to about 3:1.

In some aspects, the present disclosure relates to a method for improving a condition of a human, the method comprising administering to the human in need of an improved condition any composition, beverage, or coffee berry juice or extract described herein. Improving the condition of the human includes but is not limited to: improving cognitive function; reducing mental fatigue, improving alertness, reducing stress, improving tranquility, improving alertness, improving mental capability, improving memory capability, improving memory accuracy, improving mood, improving relaxation, reducing headache, improving/sustaining attention, improving sports performance, or any combinations thereof.

In some embodiments of the present method, the condition is improved after a time period following the administration, wherein the time period is at least about 5 minutes, or at least about 15 minutes, or at least about 30 minutes, or at least about 60 minutes, or at least about 90 minutes, or at least about 120 minutes.

The composition is administered to the human at one time, or one or more times per day.

In some embodiments of the present method, the composition administered to the human comprises at least 50 mg, at least 75 mg, at least 100 mg, or at least 125 mg of caffeine. In some embodiments, the composition administered to the human comprises at least 25 mg, at least 50 mg, or at least 75 mg, at least 100 mg, or at least 125 mg of polyphenol. In some embodiments, the composition administered to the human comprises at least 25 mg, at least 50 mg, or at least 75 mg, at least 100 mg, or at least 125 mg of chlorogenic acid.

### Definition and Interpretation of Selected Terms

As used herein, “weight percent,” “wt %, “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt %,” etc.

As used herein, “g” represents gram; “L” represents liter; “mg” represents “milligram (10⁻³ gram);” “mL” or “cc” represents milliliter (10⁻³ liter). One “μL” equals to one micron liter (10⁻⁶ liter). The units “g/100 g,” “g/100 mL,” or “g/L” are units of concentration or content of a component in a composition. One “mg/L” equals to one ppm (part per million). “Da” refers to Dalton, which is the unit for molecular weight; One Da equals to one g/mol. The unit of temperature used herein is degree Celsius (° C.).

The term “about” is used in conjunction with numeric values to include normal variations in measurements as expected by persons skilled in the art, and is understood to have the same meaning as “approximately” and to cover a typical margin of error, such as ±15%, ±10%, ±5%, ±1%, ±0.5%, or even ±0.1% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise. As used herein, “and/or” refers to and encompasses any and all possible combinations of one or more of the associated listed items, as well as the lack of combinations when interpreted in the alternative (“or”).

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

The term “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed disclosure. Thus, the term “consisting essentially of” when used in a claim of this disclosure is not intended to be interpreted to be equivalent to “comprising.”

As used herein, the terms “increase,” “increasing,” “increased,” “enhance,” “enhanced,” “enhancing,” and “enhancement” (and grammatical variations thereof) describe an elevation of at least about 1%, 5%, 10%, 15%, 25%, 50%, 75%, 100%, 150%, 200%, 300%, 400%, 500% or more as compared to a control.

As used herein, the terms “reduce,” “reduced,” “reducing,” “reduction,” “diminish,” and “decrease” (and grammatical variations thereof), describe, for example, a decrease of at least about 1%, 5%, 10%, 15%, 20%, 25%, 35%, 50%, 75%, 80%, 85%, 90%, 95%, 97%, 98%, 99%, or 100% as compared to a control. In particular embodiments, the reduction can result in no or essentially no (i.e., an insignificant amount, e.g., less than about 10% or even 5% or even 1%) detectable activity or amount.

The term “beverage” as used herein means any drinkable liquid or semi-liquid, including for example water, flavored water, soft drinks, fruit drinks, tea-based drinks, juice-based drinks, gel drinks, carbonated or non-carbonated drinks, and alcoholic or non-alcoholic drinks. In some embodiments, a beverage powder may first be mixed with any drinkable liquid or semi-liquid to obtain a beverage.

As used herein, the term “cognitive function” or “cognition” generally refers an aspect of an individual's psychosocial presentation. Cognitive function relates to multiple mental abilities, including learning, thinking, reasoning, remembering, problem solving, decision making, focusing, concentrating, and attention.

As used herein, the term “attention” refers to the ability to direct and focus cognitive activity on specific stimuli. It is the ability or power to concentrate mentally. Sustained attention refers to the state in which attention must be maintained over a period of time.

As used herein, the term “alertness” refers to the mental state of paying close and continuous attention, being watchful and prompt, or being quick to perceive and/or act. It is being vigilantly attentive, mentally responsive and perceptive, and quick.

As used herein, the term “mental fatigue” refers to a state of awareness describing a range of afflictions, associated with mental weakness. Such mental fatigue can manifest itself either as somnolence (decreased wakefulness) or as a general decrease of attention (not necessarily sleepiness). It may also be described as a decreased level of consciousness. Mental fatigue can be caused by continual mental effort and attention on a particular task, as well as high levels of stress or emotion. Basically, any mental process that goes into overload can result in mental fatigue.

As used herein, the term “mood” refers to a state or quality of feeling (an emotional state) at a particular time. Moods differ from simple emotions in that they are less specific, less intense, and less likely to be triggered by a particular stimulus or event. Moods generally have either a positive or negative valence. Mood is an internal, subjective state.

As used herein, the term “relaxation” refers to the act of mentally relaxing or the state of being mentally relaxed.

As used herein, the term “headache” refers to a persistent or lasting pain or discomfort in the head region.

As used herein, the term “sports performance” refers to an endurance sport, sustained high-intensity sport or team sports all requiring physical performance.

As used herein, “coffee berry” refers to the fruit of the coffee tree (Coffea species) in which exocarp and outer mesocarp (i.e., the pulp) surround the inner mesocarp (i.e. the mucilage) and endocarp (i.e., the hull), which in turn surround the seeds (i.e., the beans). Thus, the term coffee berry specifically refers to a whole coffee berry, which may or may not include the stem of the berry.

As used herein, the term “juice product” refers to a beverage product made from juices or combinations of juices with water or other components for human and/or animal nutritional, health-maintenance, health-improvement, and/or recreational purpose. Particularly preferred juice products include those consumed by human. “Juice” means a liquid that is found in nature in plant materials, or a diluted form of such liquid. A juice as used herein is not produced by solubilizing a plant material. “Extract” is a material that is drawn out or forcibly removed from a plant material, including through heat, chemical or high pressure means. While an extract may be in a liquid, it is not naturally found in liquid form in a plant but instead is a combination of chemical components that are not naturally found in the liquid of a plant.

As used herein, the term “nutrient” refers to a compound or mixture of compounds that is/are ingested and provides an alimentary benefit to the person ingesting the compound or mixture of compounds. Thus, the term nutrient as used herein specifically includes a compound or mixture of compounds that provide energy via metabolism of the compound or mixture of compounds (e.g., polysaccharides), interacts with the nervous system and/or immune system to modulate, and preferably stimulate, the nervous system and/or immune system (e.g., caffeine), or provides a protective function (e.g., polyphenols as antioxidant).

The term “polyphenol” as used herein refers to a diverse group of compounds produced by a plant, wherein the compounds include a phenol ring to which at least one OH group, and more typically at least two OH groups are covalently attached. For example, representative polyphenols include ellagic acid, tannic acid, vanillin, caffeic acid, CGA, ferulic acid, catechins (e.g., epicatechin gallate, epigallocatechin), flavonols (e.g., anthocyanidins, quercetin, kaempferol), and various other flavonoids, and their glycosides and depsides. Furthermore, contemplated polyphenols may also be in oligomeric or polymeric form (e.g., oligomeric proanthocyanidins or condensed tannins).

As used herein, “chlorogenic acids” refer to a family of esters formed between quinic acid and certain trans-cinnamic acids, most commonly caffeic, p-coumaric, and ferulic acid. The chlorogenic acids according to the present disclosure encompasses any isomers of caffeoylquinic acids, dicaffeoylquinic acids, feruloylquinic acids, and cumaroylquinic acids. Non-limiting examples of chlorogenic acids are provided in Table 1 shown below.

TABLE 1
Examples of chlorogenic acids.

| Example | | |
|---|---|---|
| No. | Name | Abbreviation |
| 1 | 3-O-Caffeoylquinic acid | 3-CQA |
| 2 | 4-O-Caffeoylquinic acid | 4-CQA |
| 3 | 5-O-Caffeoylquinic acid | 5-CQA |
| 4 | 3-O-Feruloylquinic acid | 3-FQA |
| 5 | 4-O-Feruloylquinic acid | 4-FQA |
| 6 | 5-O-Feruloylquinic acid | 5-FQA |
| 7 | 3-O-p-Coumaroylquinic acid | 3-pCoQA |
| 8 | 4-O-p-Coumaroylquinic acid | 4-pCoQA |
| 9 | 5-O-p-Coumaroylquinic acid | 5-pCoQA |
| 10 | 3-O-Dimethoxycinnamoylquinic acid | 3-DQA |
| 11 | 4-O-Dimethoxycinnamoylquinic acid | 4-DQA |
| 12 | 5-O-Dimethoxycinnamoylquinic acid | 5-DQA |
| 13 | 3-O-Sinapoylquinic acid | 3-SiQA |
| 14 | 4-O-Sinapoylquinic acid | 4-SiQA |
| 15 | 5-O-Sinapoylquinic acid | 5-SiQA |
| 16 | 3,4-Di-O-caffeoylquinic acid | 3,4-diCQA |
| 17 | 3,5-Di-O-caffeoylquinic acid | 3,5-diCQA |
| 18 | 4,5-Di-O-caffeoylquinic acid | 4,5-diCQA |
| 19 | 3,4-Di-O-feruloylquinic acid | 3,4-diFQA |
| 20 | 3,5-Di-O-feruloylquinic acid | 3,5-diFQA |
| 21 | 4,5-Di-O-feruloylquinic acid | 4,5-diFQA |
| 22 | 3,4-Di-O-p-coumaroylquinic acid | 3,4-dipCoQA |
| 23 | 3,5-Di-O-p-coumaroylquinic acid | 3,5-dipCoQA |
| 24 | 4,5-Di-O-p-coumaroylquinic acid | 4,5-dipCoQA |
| 25 | 3-O-Feruloyl-4-O-caffeoylquinic acid | 3F-4CQA |
| 26 | 3-O-Caffeoyl-4-O-feruloylquinic acid | 3C-4FQA |
| 27 | 3-O-Feruloyl-5-O-caffeoylquinic acid | 3F-5CQA |
| 28 | 3-O-Caffeoyl-5-O-feruloylquinic acid | 3C-5FQA |
| 29 | 4-O-Feruloyl-5-O-caffeoylquinic acid | 4F-5CQA |
| 30 | 4-O-Caffeoyl-5-O-feruloylquinic acid | 4C-5FQA |
| 31 | 3-O-Dimethoxycinnamoyl-4-O-caffeoylquinic acid | 3D-4CQA |
| 32 | 3-O-Dimethoxycinnamoyl-5-O-caffeoylquinic acid | 3D-5CQA |
| 33 | 4-O-Dimethoxycinnamoyl-5-O-caffeoylquinic acid | 4D-5CQA |
| 34 | 3-O-Dimethoxycinnamoyl-4-O-feruloylquinic acid | 3D-4FQA |
| 35 | 3-O-Dimethoxycinnamoyl-5-O-feruloylquinic acid | 3D-5FQa |
| 36 | 4-O-Dimethoxycinnamoyl-5-O-feruloylquinic acid | 4D-5FQA |
| 37 | 3-O-p-Coumaroyl-4-O-caffeoylquinic acid | 3pCo-4CQA |
| 38 | 3-O-Caffeoyl-4-O-p-coumaroylquinic acid | 3C-4pCoQA |
| 39 | 3-O-p-Coumaroyl-5-O-caffeoylquinic acid | 3pCo-5CQA |
| 40 | 3-O-Caffeoyl-5-O-p-coumaroylquinic acid | 3C-5pCoQA |
| 41 | 4-O-Caffeoyl-5-O-p-coumaroylquinic acid | 4C-5pCoQA |
| 42 | 4-O-p-Coumatoyl-5-O-caffeoylquinic acid | 4pCo-5CQA |
| 43 | 3-O-p-Coumaroyl-4-O-feruloylquinic acid | 3pCo-4FQA |
| 44 | 3-O-p-Coumaroyl-5-O-feruloylquinic acid | 3pCo-5FQA |
| 45 | 4-O-p-Coumaroyl-5-O-feruloylquinic acid | 4pCo-5FQA |
| 46 | 4-O-Dimethoxycinnamoyl-5-O-p-coumaroylquinic | 4D-5PCOQA |
| | acid | |
| 47 | 3-O-p-Coumaroyl-4-O-dimethoxycinnamoylquinic | 3pCo-4DQA |
| | acid | |
| 48 | 3-O-p-Coumaroyl-5-O-dimethoxycinnamoylquinic | 3pCo-5DQA |
| | acid | |
| 49 | 3-O-Sinapoyl-5-O-caffeoylquinic acid | 3Si-5CQA |
| 50 | 3-O-Sinapoyl-4-O-caffeoylquinic acid | 3Si-4CQA |
| 51 | 3-O)-(3,5-Dibydroxy-4-methoxy)cinnamoyl-4-O- | 3DM-4FQA |
| | feruloylquinic acid | |
| 52 | 4-O-Sinapoyl-3-O-caffeoylquinic acid | 4Si-3CQA |
| 53 | 3-O-Sinapoyl-5-O-feruloylquinic acid | 3Si-5FQA |
| 54 | 4-O-Sinapoyl-5-O-feruloylquinic acid | 4Si-5FQA |
| 55 | 4-O-Sinapoyl-3-O-feruloylquinic acid | 4Si-3FQA |
| 56 | 4-O-Trimethoxycinnamoyl-5-O-caffeoylquinic acid | 4T-5CQA |
| 57 | 3-O-Trimethoxycinnamoyl-5-O-caffeoylquinic acid | 3T-5CQA |
| 58 | 3-O-Trimethoxycinnamoyl-5-O-feruloylquinic acid | 3T-5FQA |
| 59 | 3-O-Trimethoxycinnamoyl-4-O-feruloylquinic acid | 3T-4FQA |
| 60 | 4-O-Trimethoxycinnamoyl-5-O-feruloylquinic acid | 4T-5FQA |
| 61 | 3-O-Dimethoxycinnamoyl-4-O-feruloyl-5-O- | 3D-4f-5CQA |
| | caffeoylquinic acid | |
| 62 | 3,4,5-Tri-O-caffeoylquinic acid | 3,4,5-triCQA |
| 63 | 3,5-Di-O-caffeoyl-4-O-feruloylquinic acid | 3,5-diC-4FQA |
| 64 | 3-O-Feruloyl-4,5-di-O-caffeoylquinic acid | 3F-4,5-DICQA |
| 65 | 3,4-Di-O-caffeoyl-5-O-feruloylquinic acid | 3,4-diC-5FQA |
| 66 | 3-O-Caffeoyl-4,5-di-O-feruloylquinic acid | 3C-4,5-diFQA |
| 67 | 3,4-Di-O-feruloyl-5-O-caffeoylquinic acid | 3,4-diF-5CQA |
| 68 | 3,4-Di-O-caffeoyl-5-O-sinapoylquinic acid | 3,4-diC-5SiQA |
| 69 | 3-O-Sinapoyl-4,5-di-O-caffeoylquinic acid | 3Si-4,5-DICQA |

The chlorogenic acid used herein encompasses any stereoisomers, analogues, derivatives, esters, amides, salts, conjugates, oligomers, and polymers thereof. Non-limiting examples of the chlorogenic acid derivatives include monoesters of caffeic acid (e.g., caffeoylquinic acids or CQAs, p-coumaroylquinic acids or pCoQAs, feruloylquinic acids or FQAs); diesters, triesters and a single tetraester of caffeic acid; mixed diesters of caffeic acid and either ferulic acid (e.g., caffeoylferuloylquinic acids) or sinapic acid (e.g., caffeoylsinapoylquinic acids); mixed esters derived from permutations of one to three caffeic acid moieties with one to two residues of a dicarboxylic acid (e.g., oxalic, succinic, glutaric).

The term “serving” as used herein encompasses “a serving,” “serving size,” or “serving per day,” and “served dose/dosage,” “administration,” “administration dose/dosage,” “administered units.” A “serving” “has its typical meaning as used in the art, and/or represents the amount of the composition that is administered at one moment of intake, for example as one meal or before, during and/or after a meal, before going to bed and so forth. If the composition of the present disclosure is a powdered, reconstitutable composition, or in a concentrated form, one serving size of powdered or concentrated composition is preferably mixed with about 50-500 ml, 100-400 ml, preferably 100-300 ml, more preferably 150-250 ml, for example about 240 ml carrier, such as water. If the composition is provided in the form of a liquid, ready-to-drink composition, one serving size corresponds to the amounts and preferred amounts of liquid and dry matter indicated above, for example, about 120 ml to about 480 ml (about 4 oz to about 16 oz), or from about 180 ml to about 360 ml (about 6 oz to about 12 oz), or from about 240 ml to about 300 ml (about 8 oz to about 10 oz). The daily serving of the composition of the present disclosure encompasses at least one serving per day. It is also possible to administer the daily administered amount in two or more servings, or three or more servings, for example. In this case, the size of the serving is preferably adjusted accordingly. Furthermore, the amount of the composition that needs to be administered in order to achieve the beneficial effects according to the present disclosure may be adjusted in dependence of the particular subject who wishes to enjoy the beneficial effects described herein. For example, one serving of the composition may be consumed in the morning, and one serving in the afternoon, the evening or before going to bed. One serving may be taken at breakfast and one serving is administered at dinner or after dinner, before going to bed. One serving of the composition of the present disclosure may be a part of or forms the breakfast of a human subject. Similarly, the preferred weight, weight percentage or weight percent of dry matter of any component or ingredient of the composition may be determined on the basis of indications of an amount of said component or ingredient per serving size, and/or daily serving, and vice versa, on the basis of the indications in this disclosure.

### BRIEF DESCRIPTION OF THE DRAWINGS

FIG. 1 shows an example of task assignment used for the evaluation of acute effects of example beverages on cognitive function and alertness in healthy adults function according to Example 1.

FIG. 2 shows comparative results of composite accuracy of attention for various example beverages according to Example 1.

FIG. 3 shows comparative results of accuracy of digit vigilance for various example beverages according to Example 1.

FIG. 4 shows comparative results of reaction time of digit vigilance for various example beverages according to Example 1.

FIG. 5 shows comparative results of Profile of Mood Scale (POMS) measurement for various example beverages according to Example 1.

FIG. 6 shows comparative results of measurement of picture recognition accuracy for various example beverages according to Example 1.

### DETAILED DESCRIPTION

### Compositions and Ingredients

In one aspect, the present disclosure relates to an edible composition comprising: caffeine and/or a derivative thereof; and a polyphenol, wherein the composition has a weight ratio of the total polyphenol to the total caffeine from about 1:10 to about 10:1. In some embodiments, the polyphenol comprises a phenolic acid derived from a natural resource as such fruit or vegetables.

The term “phenolic acids” generally describes the phenolic compounds having one carboxylic acid group. Phenolic or phenolcarboxylic acids (a type of phytochemical called a polyphenol) are one of the main classes of plant phenolic compounds. In some embodiments, the phenolic acids are present in bound from such as amides, esters, glycosides, oligomeric or polymeric form. In certain embodiments, the phenolic acid comprises a chlorogenic acid selected from the group of caffeoylquinic acids, dicaffeoylquinic acids, feruloylquinic acids, cumaroylquinic acids, or a derivative thereof, or any combinations thereof.

The present disclosure is based, at least in part, on the surprising findings that administration of edible compositions or beverages having both caffeine and a polyphenol comprising one or more chlorogenic acid with a weight ratio of chlorogenic acid to caffeine from about 1:10 to about 10:1 are effective in improving one or more of the following conditions or functions: improving cognitive function; reducing mental fatigue, improving alertness, reducing stress, improving tranquility, improving alertness, improving mental capability, improving memory capability, improving memory accuracy, improving mood, improving relaxation, reducing headache, improving/sustaining attention, improving sports performance.

Results from a randomized, double-blind, placebo-controlled, balanced cross-over trial study (See Example 1) indicated that the present compositions are significantly better than conventional caffeinated beverages or decaffeinated beverages in various cognition/alertness tests on healthy humans.

### Caffeine and Polyphenol

In some embodiments, the present composition comprises a caffeine or a functional analogue, derivative, metabolites, or variation thereof; and a polyphenol or a functional analogue, derivative, metabolites, or variation thereof. Although consumption of caffeine is generally known to have positive health effects on human such as performance improvement, fatigue reduction, and decreased irritability, over consumption of caffeine may induce caffeine intoxication (caffeinism). It is for the first time identified in the present disclosure that a balanced dosage of caffeine and polyphenol have synergistic effect in improving the positive health benefits associated with cognitive function and/or alertness, when comparing with caffeine alone.

In some embodiments, the present composition has a weight ratio of the total polyphenol to the total caffeine from about 1:10 to about 10:1, from about 1:8 to about 8:1, or from about 1:6 to about 6:1, or from about 1:4 to about 4:1, from about 1:2 to about 3:1, from about 1:1 to about 3:1, from about 1.5:1 to about 2:1, or from about 1:1. In some embodiments, the weight ratio of the total polyphenol to the total caffeine is at least about 1:1, at least about 1.1:1, at least about 1.2:1, at least about 1.3:1, at least about 1.4:1, at least about 1.5:1, at least about 1.6:1, at least about 1.7:1, at least about 1.8:1, at least about 1.9:1, at least about 2:1, at least about 2.1:1, at least about 2.2:1, at least about 2.3:1, at least about 2.4:1, at least about 2.5:1, at least about 3:1, at least about 3.5:1, at least about 4:1, or at least about 5:1. In some embodiments, the weight ratio of the total polyphenol to the total caffeine is at least about 1:10, at least about 1:9, at least about 1:8, at least about 1:7, at least about 1:6, at least about 1:5, at least about 1:4, at least about 1:3, at least about 1:2, or at least about 1:1.5.

In some embodiments, the weight ratio of the total polyphenol to the total caffeine is at most about 10:1, or about most about 9:1, or at most about 8:1, or at most about 7:1, or at most about 6:1, or at most about 5:1, or at most about 4:1, or at most about 3:1, or at most about 2:1, or at most 1:1, or at most 1:1.5, or at most 1:2, or at most 1:3, or at most 1:4, or at most 1:5, or at most 1:6, or at most 1:7, or at most 1:8, or at most 1:9, or at most 1:10.

In some embodiments, the present composition has a total content of caffeine from about 0.01 wt % to about 5 wt %, or from about 0.05 wt % to about 4 wt %, or from about 0.1 wt % to about 3 wt %, or from about 0.5 wt % to about 2 wt %, or from about 1 wt % to about 1.5 wt %. In some embodiments, the present composition has a total content of caffeine of at least 0.01 wt %, at least 0.05 wt %, at least 0.1 wt %, at least 0.2 wt %, at least 0.3 wt %, at least 0.4 wt %, at least 0.5 wt %, at least 0.6 wt %, at least 0.7 wt %, at least 0.8 wt %, at least 0.9 wt %, at least 1 wt %, at least 1.1 wt %, at least 1.2 wt %, at least 1.3 wt %, at least 1.4 wt %, at least 1.5 wt %, at least 1.6 wt %, at least 1.7 wt %, at least 1.8 wt %, at least 1.9 wt %, at least 2.0 wt %, at least 2.1 wt %, at least 2.2 wt %, at least 2.3 wt %, at least 2.4 wt %, at least 2.5 wt %, at least 3 wt %, at least 3.5 wt %, at least 4 wt %, at least 4.5 wt %, or at least 5 wt %. In some embodiments, the present composition has a total content of caffeine of at most 5 wt %, at most 4.5 wt %, at most 4 wt %, at most 3.5 wt %, at most 3 wt %, at most 2.5 wt %, at most 2 wt %, at most 1.5 wt %, at most 1 wt %.

In some embodiments, the present composition has a dosage of caffeine from about 10 mg to about 500 mg, or from about 20 mg to about 400 mg, or from about 30 mg to about 300 mg, from about 40 mg to about 200 mg, from about 50 mg to about 180 mg, from about 60 mg to about 160 mg, from about 70 mg to about 140, from about 80 mg to about 140 mg, or from about 90 mg to about 120 mg for one serving. In some embodiments, the present composition has a dosage of caffeine of at least 25 mg, at least 50 mg, at least 75 mg, at least 100 mg, at least 125 mg, at least 150 mg, at least 175 mg, at least 200 mg, at least 250 mg, at least 300 mg, at least 350 mg, or at least 400 mg. In some embodiments, the present composition has a dosage of caffeine of at most 500 mg, at most 450 mg, at most 400 mg, at most 350 mg, at most 300 mg, at most 250 mg, at most 200 mg, or at most 150 mg.

In some embodiments, the present composition has a total content of polyphenol from about 0.01 wt % to about 5 wt %, or from about 0.05 wt % to about 4 wt %, or from about 0.1 wt % to about 3 wt %, or from about 0.5 wt % to about 2 wt %, or from about 1 wt % to about 1.5 wt %. In some embodiments, the present composition has a total content of polyphenol of at least 0.01 wt %, at least 0.05 wt %, at least 0.1 wt %, at least 0.2 wt %, at least 0.3 wt %, at least 0.4 wt %, at least 0.5 wt %, at least 0.6 wt %, at least 0.7 wt %, at least 0.8 wt %, at least 0.9 wt %, at least 1 wt %, at least 1.1 wt %, at least 1.2 wt %, at least 1.3 wt %, at least 1.4 wt %, at least 1.5 wt %, at least 1.6 wt %, at least 1.7 wt %, at least 1.8 wt %, at least 1.9 wt %, at least 2.0 wt %, at least 2.1 wt %, at least 2.2 wt %, at least 2.3 wt %, at least 2.4 wt %, at least 2.5 wt %, at least 3 wt %, at least 3.5 wt %, at least 4 wt %, at least 4.5 wt %, or at least 5 wt %. In some embodiments, the present composition has a total content of polyphenol of at most 10 wt %, at most 9 wt %, at most 8 wt %, at most 7 wt %, at most 6 wt %, at most 5 wt %, at most 4 wt %, at most 3 wt %, at most 2 wt %.

In some embodiments, the present composition has a dosage of polyphenol from about 10 mg to about 1,000 mg, or from about 20 mg to about 800 mg, or from about 30 mg to about 600 mg, from about 40 mg to about 500 mg, from about 50 mg to about 400 mg, from about 60 mg to about 300 mg, from about 70 mg to about 250, from about 80 mg to about 200 mg, or from about 90 mg to about 150 mg for one serving. In some embodiments, the present composition has a dosage of polyphenol of at least 25 mg, at least 50 mg, at least 75 mg, at least 100 mg, at least 125 mg, at least 150 mg, at least 175 mg, at least 200 mg, at least 250 mg, at least 300 mg, at least 350 mg, at least 400 mg, at least 500 mg, at least 600 mg, at least 700 mg, at least 800 mg, at least 900 mg, or at least 1,000 mg for one serving. In some embodiments, the present composition has a dosage of polyphenol of at most 1,000 mg, at most 900 mg, at most 800 mg, at most 700 mg, at most 6000 mg, at most 5000 mg, at most 400 mg, or at most 300 mg for one serving.

In some embodiments, the present composition comprises caffeine and one or more chlorogenic acids. The present composition may have a weight ratio of the total chlorogenic acids to the total caffeine from about 1:10 to about 10:1, from about 1:8 to about 8:1, or from about 1:6 to about 6:1, or from about 1:4 to about 4:1, from about 1:2 to about 3:1, from about 1:1 to about 3:1, from about 1.5:1 to about 2:1, or from about 1:1. In some embodiments, the weight ratio of the total chlorogenic acids to the total caffeine is at least about 1:1, at least about 1.1:1, at least about 1.2:1, at least about 1.3:1, at least about 1.4:1, at least about 1.5:1, at least about 1.6:1, at least about 1.7:1, at least about 1.8:1, at least about 1.9:1, at least about 2:1, at least about 2.1:1, at least about 2.2:1, at least about 2.3:1, at least about 2.4:1, at least about 2.5:1, at least about 3:1, at least about 3.5:1, at least about 4:1, or at least about 5:1. In some embodiments, the weight ratio of the total chlorogenic acids to the total caffeine is at least about 1:10, at least about 1:9, at least about 1:8, at least about 1:7, at least about 1:6, at least about 1:5, at least about 1:4, at least about 1:3, at least about 1:2, or at least about 1:1.5.

In some embodiments of the present composition, the weight ratio of the total chlorogenic acids to the total caffeine is at most about 10:1, or about most about 9:1, or at most about 8:1, or at most about 7:1, or at most about 6:1, or at most about 5:1, or at most about 4:1, or at most about 3:1, or at most about 2:1, or at most 1:1, or at most 1:1.5, or at most 1:2, or at most 1:3, or at most 1:4, or at most 1:5, or at most 1:6, or at most 1:7, or at most 1:8, or at most 1:9, or at most 1:10.

In some embodiments, the present composition has a total content of chlorogenic acids from about 0.01 wt % to about 5 wt %, or from about 0.05 wt % to about 4 wt %, or from about 0.1 wt % to about 3 wt %, or from about 0.5 wt % to about 2 wt %, or from about 1 wt % to about 1.5 wt %. In some embodiments, the present composition has a total content of chlorogenic acids of at least 0.01 wt %, at least 0.05 wt %, at least 0.1 wt %, at least 0.2 wt %, at least 0.3 wt %, at least 0.4 wt %, at least 0.5 wt %, at least 0.6 wt %, at least 0.7 wt %, at least 0.8 wt %, at least 0.9 wt %, at least 1 wt %, at least 1.1 wt %, at least 1.2 wt %, at least 1.3 wt %, at least 1.4 wt %, at least 1.5 wt %, at least 1.6 wt %, at least 1.7 wt %, at least 1.8 wt %, at least 1.9 wt %, at least 2.0 wt %, at least 2.1 wt %, at least 2.2 wt %, at least 2.3 wt %, at least 2.4 wt %, at least 2.5 wt %, at least 3 wt %, at least 3.5 wt %, at least 4 wt %, at least 4.5 wt %, or at least 5 wt %. In some embodiments, the present composition has a total content of chlorogenic acids of at most 10 wt %, at most 9 wt %, at most 8 wt %, at most 7 wt %, at most 6 wt %, at most 5 wt %, at most 4 wt %, at most 3 wt %, at most 2 wt %.

In some embodiments, the present composition has a dosage of chlorogenic acids from about 10 mg to about 1,000 mg, or from about 20 mg to about 800 mg, or from about 30 mg to about 600 mg, from about 40 mg to about 500 mg, from about 50 mg to about 400 mg, from about 60 mg to about 300 mg, from about 70 mg to about 250, from about 80 mg to about 200 mg, or from about 90 mg to about 150 mg for one serving. In some embodiments, the present composition has a dosage of chlorogenic acids of at least 25 mg, at least 50 mg, at least 75 mg, at least 100 mg, at least 125 mg, at least 150 mg, at least 175 mg, at least 200 mg, at least 250 mg, at least 300 mg, at least 350 mg, at least 400 mg, at least 500 mg, at least 600 mg, at least 700 mg, at least 800 mg, at least 900 mg, or at least 1,000 mg for one serving. In some embodiments, the present composition has a dosage of chlorogenic acids of at most 1,000 mg, at most 900 mg, at most 800 mg, at most 700 mg, at most 6000 mg, at most 5000 mg, at most 400 mg, or at most 300 mg for one serving.

### Additional/Functional Ingredients

The present oral composition can contain additional typical beverage ingredients, e.g. at least one sweetener and/or at least one functional ingredient and/or at least one additive.

### Sweetener

The present composition may optionally include a sweetener. The sweetener can be an artificial or synthetic sweetener, a natural sweetener, a natural high potency sweetener. As used herein, the phrase “natural high potency sweetener” (NHPS) refers to any sweetener found naturally in nature and characteristically has a sweetness potency greater than sucrose, fructose, or glucose, yet has less calories. The natural high potency sweetener can be provided as a pure compound or, alternatively, as part of an extract. As used herein, the phrase “synthetic sweetener” refers to any composition which is not found naturally in nature and characteristically has a sweetness potency greater than sucrose, fructose, or glucose, yet has less calories.

Non-limiting examples of NHPSs includes stevia and steviol glycosides, such as rebaudioside M, rebaudioside D, rebaudioside A, rebaudioside N, rebaudioside O, rebaudioside E, steviolmonoside, steviolbioside, rubusoside, dulcoside B, dulcoside A, rebaudioside B, rebaudioside G, stevioside, rebaudioside C, rebaudioside F, rebaudioside I, rebaudioside H, rebaudioside L, rebaudioside K, rebaudioside J, rebaudioside M2, rebaudioside D2, rebaudioside S, rebaudioside T, rebaudioside U, rebaudioside V, rebaudioside W, rebaudioside Z1, rebaudioside Z2, rebaudioside IX, enzymatically glucosylated steviol glycosides and combinations thereof. Examples of high purity steviol glycosides and methods of making the same are provided in U.S. Pat. App. No. 2021/0107933, which is hereby incorporated in its entirety.

In certain embodiments, a steviol glycoside blend comprises at least about 5% steviol glycoside by weight, such as, for example, at least about 10%, at least about 20%, at least about 30%, at least about 40%, at least about 50%, at least about 60%, at least about 70%, at least about 80%, at least about 90%, at least about 95% or at least about 97%. In exemplary embodiments, the steviol glycoside blend comprises at least about 50% steviol glycoside by weight, such as, for example, from about 50% to about 90%, from about 50% to about 80%, from about 50% to about 70%, from about 50% to about 60%, from about 60% to about 90%, from about 60% to about 80%, from about 60% to about 70%, from about 70% to about 90%, from about 70% to about 80% and from about 80% to about 90%.

Another exemplary NHPS is Luo Han Guo and the related mogroside compounds, such as grosmogroside I, mogroside IA, mogroside IE, 11-oxomogroside IA, mogroside II, mogroside II A, mogroside II B, mogroside II E, 7-oxomogroside II E, mogroside III, Mogroside HIE, 11-oxomogroside HIE, 11-deoxymogroside III, mogroside IV, Mogroside IVA 11-oxomogroside IV, 11-oxomogroside IVA, mogroside V, isomogroside V, 11-deoxymogroside V, 7-oxomogroside V, 11-oxomogroside V, isomogroside V, mogroside VI, mogrol, 11-oxomogrol, siamenoside I, isomers of siamenoside I (e.g. those disclosed in US Pat. App. No. 20170119032; incorporated by reference in its entirety), (3β, 9β, 10α, 11α, 24R)-3-[(4-O-β-D-glucospyranosyl-6-O-β-D-glucopyranosyl]-25-hydroxyl-9-methyl-19-norlanost-5-en-24-yl-[2-O-β-D-glucopyranosyl-6-O-β-D-glucopyranosyl]-β-D-glucopyranoside); (3β, 9β, 10α, 11α, 24R)-[(2-O-β-D-glucopyranosyl-6-O-β-D-glucopyranosyl-β-D-glucopyranosyl)oxy]-25-hydroxy-9-methyl-19-norlanost-5-en-24-yl-[2-O-β-D-glucopyranosyl-6-O-β-D-glucopyranosyl]-β-D-glucopyranoside); and (3β, 9β, 10α, 11α, 24R)-[(2-O-β-D-glucopyranosyl-6-O-β-D-glucopyranosyl-β-D-glucopyranosyl)oxy]-25-hydroxy-9-methyl-19-norlanost-5-en-24-yl-[2-O-β-D-glucopyranosyl-6-O-β-D-glucopyranosyl]-β-D-glucopyranoside).

In certain embodiments, a mogroside blend comprises at least about 5% of the mogroside by weight, such as, for example, at least about 10%, at least about 20%, at least about 30%, at least about 40%, at least about 50%, at least about 60%, at least about 70%, at least about 80%, at least about 90%, at least about 95% or at least about 97%.

Other exemplary NHPSs include monatin and its salts (monatin SS, RR, RS, SR), curculin, glycyrrhizic acid and its salts, thaumatin, monellin, mabinlin, brazzein, hemandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I.

In one embodiment, the sweetener is a carbohydrate sweetener. Suitable carbohydrate sweeteners include, but not limited to, the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, arabinose, turanose, sialose and combinations thereof.

In certain embodiments, the present composition is free or substantially free from a carbohydrate sweetener.

Other suitable sweeteners include siamenoside, monatin and its salts (monatin SS, RR, RS, SR), curculin, mogrosides, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, steviolbioside and cyclocarioside I, sugar alcohols such as erythritol, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

In one embodiment, the sweetener is a caloric sweetener or mixture of caloric sweeteners. In another embodiment, the caloric sweetener is selected from sucrose, fructose, glucose, high fructose com/starch syrup, a beet sugar, a cane sugar, and combinations thereof.

In certain embodiments, the present composition is free or substantially free from a caloric sweetener.

In another embodiment, the sweetener is a rare sugar selected from allulose, gulose, kojibiose, sorbose, lyxose, ribulose, xylose, xylulose, D-allose, L-ribose, D-tagatose, L-glucose, L-fucose, L-arabinose, turanose and combinations thereof.

The amount of sweetener in the present composition depends on the identity of the sweetener and the desired level of sweetness. In preferred embodiments, the sweetener is present in a sweetening amount, i.e. a concentration that is detectably sweet.

As would be understood by a person of skill in the art, high potency sweeteners are more potent and therefore lower concentrations are required to achieve a particular sucrose equivalence (SE). The sweetness of a non-sucrose sweetener can be measured against a sucrose reference by determining the non-sucrose sweetener's sucrose equivalence (SE). Typically, taste panelists are trained to detect sweetness of reference sucrose solutions containing between 1-15% sucrose (w/v). Other non-sucrose sweeteners are then tasted at a series of dilutions to determine the concentration of the non-sucrose sweetener that is as sweet as a given percent sucrose reference. For example, if a 1% solution of a non-sucrose sweetener is as sweet as a 10% sucrose solution, then the sweetener is said to be 10 times as potent as sucrose, and has 10% sucrose equivalence.

In one embodiment, the sweetener or sweeteners provides the present composition with a sucrose equivalence of about 1 wt %, such as, for example, about 2%, about 3%, about 4%, about 5%, about 6%, about 7%, about 8%, about 9%, about 10%, about 11%, about 12%, about 13%, about 14% or any range between these values.

In another embodiment, the present composition has a SE from about 2% to about 14%, such as, for example, from about 2% to about 10%, from about 2% to about 5%, from about 5% to about 15%, from about 5% to about 10% or from about 10% to about 15%.

The amount of sucrose, and thus another measure of sweetness, in a reference solution may be described in degrees Brix (° Bx). One degree Brix is 1 gram of sucrose in 100 grams of solution and represents the strength of the solution as percentage by weight (% w/w) (strictly speaking, by mass). In embodiments where the present composition is sweetened with a sweetener, the composition has a Brix value of about 3° to about 25°, or about 5° to about 20°, or about 7° to about 15°. In some embodiments, the composition can be at least about 1° Bx, about 2° Bx, about 3° Bx, about 4° Bx, about 5° Bx, about 6° Bx, about 7° Bx, about 8° Bx, about 9° Bx, about 10° Bx, about 11° Bx, about 12° Bx, about 13° Bx, about 14° Bx, about 15° Bx, about 16° Bx, about 17° Bx, about 18° Bx, about 19° Bx, about 20° Bx, about 21° Bx, about 22° Bx, about 23° Bx, about 24° Bx, about 25° Bx, or any range between these values.

The present composition may optionally include a functional ingredient. Exemplary functional ingredients include, but are not limited to, electrolytes, saponins, antioxidants, dietary fiber sources, fatty acids, vitamins, glucosamine, minerals, preservatives, hydration agents, probiotics, prebiotics, weight management agents, osteoporosis management agents, terpenes or derivatives thereof, phytoestrogens, long chain primary aliphatic saturated alcohols, phytosterols and combinations thereof.

### Terpene and Derivatives

In some embodiments, the present composition comprises a terpene, a diterpene, a triterpene or any derivatives thereof. In some embodiments, the present composition has a total content of terpene from about 0.01 wt % to about 5 wt %, or from about 0.05 wt % to about 4 wt %, or from about 0.1 wt % to about 3 wt %, or from about 0.5 wt % to about 2 wt %, or from about 1 wt % to about 1.5 wt %.

In some embodiments, the present composition comprises a terpene derivative such as terpene glycoside. Non-limiting examples of terpene glycosides include: rebaudioside A; rebaudioside B; rebaudioside C; rebaudioside D; rebaudioside E; rebaudioside F; stevioside; steviolbioside; dulcoside A; rubusoside; steviol; steviol 13 O-β-D-glycoside; suavioside A; suavioside B; suavioside G; suavioside H; suavioside I; suavioside J; isosteviol; 13-[(2-O-(3-O-α-D-glucopyranosyl)-β-D-glucopyranosyl-3-O-β-D-glucopyranosyl-β-D-glucopyranosyl)oxy]kaur-16-en-18-oic acid β-D-glucopyranosyl ester; 13-[(2-O-β-D-glucopyranosyl-3-O-(4-O-α-D-glucopyranosyl)-β-D-glucopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-hydroxy-kaur-16-en-18-oic acid β-D-glucopyranosyl ester; 13-methyl-16-oxo-17-norkauran-18-oic acid β-D-glucopyranosyl ester; 13-[(2-O-β-D-glucopyranosyl-3-O-β-D-glucopyranosyl-β-D-glucopyranosyl)oxy]kaur-15-en-18-oic acid β-D-glucopyranosyl ester; 13-[(2-O-β-D-glucopyranosyl-3-O-β-D-glucopyranosyl-β-D-glucopyranosyl)oxy]kaur-15-en-18-oic acid; 13-[(2-O-β-D-glucopyranosyl-3-O-β-D-glucopyranosyl]-β-D-glucopyranosyl)oxy]-17-hydroxy-kaur-15-en-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid; 1-[13-hydroxykaur-16-en-18-oate]β-D-glucopyranuronic acid; 13-[(2-O-β-D-glucopyranosyl-β-D-glucopyranosyl)oxy]-17-hydroxy-kaur-15-en-18-oic acid β-D-glucopyranosyl ester; 13-[(2-O-α-L-rhamnopyranosyl-3-O-β-D-glucopyranosyl-β-D-glucopyranosyl)oxy]kaur-16-en-18-oic acid-(2-O-β-D-glucopyranosyl-β-D-glucopyranosyl) ester; 13-[(2-O-β-D-glucopyranosyl-β-D-glucopyranosyl)oxy]-17-oxo-kaur-15-en-18-oic acid β-D-glucopyranosyl ester; 13-[(2-O-β-D-glucopyranosyl-β-D-glucopyranosyl)oxy]-17-oxo-kaur-15-en-18-oic acid β-D-glucopyranosyl ester; 13-[(2-O-(6-O-β-D-glucopyranosyl)-β-D-glucopyranosyl-β-D-glucopyranosyl)oxy]kaur-16-en-18-oic acid β-D-glucopyranosyl ester; 13-[(2-O-β-D-glucopyranosyl-3-O-β-D-fructofuranosyl-β-D-glucopyranosyl)oxy]kaur-16-en-18-oic acid β-D-glucopyranosyl ester; 13-[(2-O-β-D-glucopyranosyl-β-D-glucopyranosyl)oxy]kaur-16-en-18-oic acid-(6-O-β-D-xylopyranosyl-β-D-glucopyranosyl) ester; 13-[(2-O-β-D-glucopyranosyl-β-D-glucopyranosyl)oxy]kaur-16-en-18-oic acid-(4-O-(2-O-α-D-glucopyranosyl)-α-D-glucopyranosyl-β-D-glucopyranosyl) ester; 13-[(2-O-β-D-glucopyranosyl-3-O-β-D-glucopyranosyl-β-D-glucopyranosyl)oxy]kaur-16-en-18-oic acid-(2-O-6-deoxy-β-D-glucopyranosyl-β-D-glucopyranosyl) ester; 13-[(2-O-β-D-glucopyranosyl-β-D-glucopyranosyl)oxy]kaur-15-en-18-oic acid β-D-glucopyranosyl ester; 13-[(2-O-β-D-glucopyranosyl-3-O-β-D-xylopyranosyl-β-D-glucopyranosyl)oxy]kaur-16-en-18-oic acid β p-D-glucopyranosyl ester; 13-[(2-O-β-D-xylopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-[(2-O-6-deoxy-β-D-glucopyranosyl-3-O-β-D-glucopyranosyl-β-D-glucopyranosyl)oxy]kaur-16-en-18-oic acid β-D-glucopyranosyl ester; 13-[(2-O-6-deoxy-β-D-glucopyranosyl-β-D-glucopyranosyl)oxy]kaur-16-en-18-oic acid β-D-glucopyranosyl ester mogroside E; mogroside I A; mogroside I E; mogroside II A; mogroside II A1; mogroside II B; mogroside II E; mogroside III; mogroside III A2; mogroside IV; mogroside IV A; mogroside V; mogroside VI; 11-oxomogroside; 11-oxomogroside I A; 11-oxomogroside I A1; 20-hydroxy-11-oxomogroside I A1; 11-oxomogroside II A1; 7-oxomogroside II E; 11-oxomogroside II E; 11-deoxymogroside III; 11-oxomogroside IV A; 7-oxomogroside V; 11-oxomogroside V; mogrol; 11-oxo-mogrol; siamenoside; siamenoside-1; isomogroside; isomogroside V; and polymorphic and amorphous forms thereof.

In certain embodiments, the terpene derivative is at least one saponin. As used herein, the at least one saponin may comprise a single saponin or a plurality of saponins as a functional ingredient for the composition provided herein. Saponins are glycosidic natural plant products comprising an aglycone ring structure and one or more sugar moieties. Non-limiting examples of specific saponins for use in particular embodiments of the disclosure include group A acetyl saponin, group B acetyl saponin, and group E acetyl saponin. Several common sources of saponins include soybeans, which have approximately 5% saponin content by dry weight, soapwort plants Saponaria), the root of which was used historically as soap, as well as alfalfa, aloe, asparagus, grapes, chickpeas, yucca, and various other beans and weeds. Saponins may be obtained from these sources by using extraction techniques well known to those of ordinary skill in the art. A description of conventional extraction techniques can be found in U.S. Pat. Pub. No. 20050123662.

In some embodiments, the present composition has a content of total terpenes from about 0.01 wt % to about 5 wt %, or from about 0.05 wt % to about 4 wt %, or from about 0.1 wt % to about 3 wt %, or from about 0.5 wt % to about 2 wt %, or from about 1 wt % to about 1.5 wt %. In some embodiments, the present composition has a dosage of total terpenes from about 10 mg to about 1,000 mg, or from about 20 mg to about 800 mg, or from about 30 mg to about 600 mg, from about 40 mg to about 500 mg, from about 50 mg to about 400 mg, from about 60 mg to about 300 mg, from about 70 mg to about 250, from about 80 mg to about 200 mg, or from about 90 mg to about 150 mg for one serving.

### Antioxidant

In certain embodiments, the functional ingredient is at least one antioxidant. As used herein, “antioxidant” refers to any substance which inhibits, suppresses, or reduces oxidative damage to cells and biomolecules.

Examples of suitable antioxidants for embodiments of this disclosure include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, oc-carotene, b-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), buty lated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-oc-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (i.e. VINOSEED), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example. Other sources of suitable antioxidants for embodiments of this disclosure include, but are not limited to, fruits, vegetables, tea, cocoa, chocolate, spices, herbs, rice, organ meats from livestock, yeast, whole grains, or cereal grains.

It is noted that the polyphenol, phenolic acid, or chlorogenic acid contained in the present compositions can also serve as antioxidants. Other suitable polyphenols for embodiments of this disclosure, as mentioned supra, can include catechins, proanthocyanidins, procyanidins, anthocyanins, quercerin, rutin, reservatrol, isoflavones, curcumin, punicalagin, ellagitannin, hesperidin, naringin, citrus flavonoids, other similar materials, and combinations thereof. In one embodiment, the present composition includes antioxidant comprising a catechin such as, for example, epigallocatechin gallate (EGCG).

### Dietary Fiber

In certain embodiments, the functional ingredient is at least one dietary fiber. Numerous polymeric carbohydrates having significantly different structures in both composition and linkages fall within the definition of dietary fiber. Such compounds are well known to those skilled in the art, non-limiting examples of which include non-starch polysaccharides, lignin, cellulose, methylcellulose, the hemicelluloses, b-glucans, pectins, gums, mucilage, waxes, inulins, oligosaccharides, fructooligosaccharides, cyclodextrins, chitins, and combinations thereof. Although dietary fiber generally is derived from plant sources, indigestible animal products such as chitins are also classified as dietary fiber. Chitin is a polysaccharide composed of units of acetylglucosamine joined by b(1-4) linkages, similar to the linkages of cellulose.

### Fatty Acid

In certain embodiments, the functional ingredient is at least one fatty acid. As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” any polyunsaturated fatty acid having a first double bond as the sixth carbon-carbon bond from the terminal methyl end of its carbon chain.

Suitable omega-3 fatty acids for use in embodiments of the present disclosure can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils such as Microalgae DHA oil (from Martek, Columbia, MD), OmegaPure (from Omega Protein, Houston, TX), Marinol C-38 (from Lipid Nutrition, Channahon, IL), Bonito oil and MEG-3 (from Ocean Nutrition, Dartmouth, NS), Evogel (from Symrise, Holzminden, Germany), Marine Oil, from tuna or salmon (from Arista Wilton, CT), OmegaSource 2000, Marine Oil, from menhaden and Marine Oil, from cod (from OmegaSource, RTP, NC). Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof.

Suitable esterified fatty acids for embodiments of the present disclosure include, but are not limited to, monoacylgycerols containing omega-3 and/or omega-6 fatty acids, diacylgycerols containing omega-3 and/or omega-6 fatty acids, or triacylgycerols containing omega-3 and/or omega-6 fatty acids and combinations thereof.

### Vitamin

In certain embodiments, the functional ingredient is at least one vitamin. Suitable vitamins include, vitamin A, vitamin D, vitamin E, vitamin K, vitamin B1, vitamin B2, vitamin B3, vitamin B5, vitamin B6, vitamin B7, vitamin B9, vitamin B 12, and vitamin C.

Various other compounds have been classified as vitamins by some authorities. These compounds may be termed pseudo-vitamins and include, but are not limited to, compounds such as ubiquinone (coenzyme Q10), pangamic acid, dimethylglycine, taestrile, amygdaline, flavanoids, para-aminobenzoic acid, adenine, adenylic acid, and s-methylmethionine. As used herein, the term vitamin includes pseudo-vitamins. In some embodiments, the vitamin is a fat-soluble vitamin chosen from vitamin A, D, E, K and combinations thereof. In other embodiments, the vitamin is a water-soluble vitamin chosen from vitamin B1, vitamin B2, vitamin B3, vitamin B6, vitamin B12, folic acid, biotin, pantothenic acid, vitamin C and combinations thereof.

### Mineral

In certain embodiments, the functional ingredient is at least one mineral. Minerals, in accordance with the teachings of this disclosure, comprise inorganic chemical elements required by living organisms. Minerals are comprised of a broad range of compositions (e.g., elements, simple salts, and complex silicates) and also vary broadly in crystalline structure. They may naturally occur in foods and beverages, may be added as a supplement, or may be consumed or administered separately from foods or beverages.

Minerals may be categorized as either bulk minerals, which are required in relatively large amounts, or trace minerals, which are required in relatively small amounts. Bulk minerals generally are required in amounts greater than or equal to about 100 mg per day and trace minerals are those that are required in amounts less than about 100 mg per day. In one embodiment, the mineral is chosen from bulk minerals, trace minerals or combinations thereof. Non-limiting examples of bulk minerals include calcium, chlorine, magnesium, phosphorous, potassium, sodium, and sulfur. Non-limiting examples of trace minerals include chromium, cobalt, copper, fluorine, iron, manganese, molybdenum, selenium, zinc, and iodine. Although iodine generally is classified as a trace mineral, it is required in larger quantities than other trace minerals and often is categorized as a bulk mineral.

In a particular embodiment, the mineral is a trace mineral, believed to be necessary for human nutrition, non-limiting examples of which include bismuth, boron, lithium, nickel, rubidium, silicon, strontium, tellurium, tin, titanium, tungsten, and vanadium.

The minerals embodied herein may be in any form known to those of ordinary skill in the art. For example, in one embodiment, the minerals may be in their ionic form, having either a positive or negative charge. In another embodiment, the minerals may be in their molecular form. For example, sulfur and phosphorous often are found naturally as sulfates, sulfides, and phosphates.

### Preservative

In certain embodiments, the functional ingredient is at least one preservative. In particular embodiments, the preservative is chosen from antimicrobials, antioxidants, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, and ozone. In one embodiment, the preservative is a sulfite. Sulfites include, but are not limited to, sulfur dioxide, sodium bisulfite, and potassium hydrogen sulfite. In another embodiment, the preservative is a propionate. Propionates include, but are not limited to, propionic acid, calcium propionate, and sodium propionate. In yet another embodiment, the preservative is a benzoate. Benzoates include, but are not limited to, sodium benzoate and benzoic acid. In still another embodiment, the preservative is a sorbate. Sorbates include, but are not limited to, potassium sorbate, sodium sorbate, calcium sorbate, and sorbic acid. In a still further embodiment, the preservative is a nitrate and/or a nitrite. Nitrates and nitrites include, but are not limited to, sodium nitrate and sodium nitrite. In another embodiment, the at least one preservative is a bacteriocin, such as, for example, nisin. In still another embodiment, the preservative is ethanol. In yet another embodiment, the preservative is ozone. Non-limiting examples of anti-enzymatis suitable for use as preservatives in particular embodiments of the disclosure include ascorbic acid, citric acid, and metal chelating agents such as ethylenediaminetetraacetic acid (EDTA). In some embodiments, the present composition is free or substantially free from a preservative.

### Probiotic

In certain embodiments, the functional ingredient is chosen from at least one probiotic, prebiotic and combination thereof. The probiotic is a beneficial microorganism that affects the human body's naturally-occurring gastrointestinal microflora. Examples of probiotics include, but are not limited to, bacteria of the genus Lactobacilli, Bifidobacteria, Streptococci, or combinations thereof, that confer beneficial effects to humans. In particular embodiments of the disclosure, the at least one probiotic is chosen from the genus Lactobacilli. According to other particular embodiments of this disclosure, the probiotic is chosen from the genus Bifidobacteria. In a particular embodiment, the probiotic is chosen from the genus Streptococcus.

Probiotics that may be used in accordance with this disclosure are well-known to those of skill in the art. Non-limiting examples of foodstuffs comprising probiotics include yogurt, sauerkraut, kefir, kimchi, fermented vegetables, and other foodstuffs containing a microbial element that beneficially affects the host animal by improving the intestinal microbalance.

Prebiotics, in accordance with the embodiments of this disclosure, include, without limitation, mucopolysaccharides, oligosaccharides, polysaccharides, amino acids, vitamins, nutrient precursors, proteins and combinations thereof. According to a particular embodiment of this disclosure, the prebiotic is chosen from dietary fibers, including, without limitation, polysaccharides and oligosaccharides. Non-limiting examples of oligosaccharides that are categorized as prebiotics in accordance with particular embodiments of this disclosure include fructooligosaccharides, inulins, isomalto-oligosaccharides, lactilol, lactosucrose, lactulose, pyrodextrins, soy oligosaccharides, transgalacto-oligosaccharides, and xylo-oligosaccharides. In other embodiments, the prebiotic is an amino acid. Although a number of known prebiotics break down to provide carbohydrates for probiotics, some probiotics also require amino acids for nourishment.

In some embodiments, the present composition is free or substantially free from probiotics.

### Prebiotics

Prebiotics are found naturally in a variety of foods including, without limitation, bananas, berries, asparagus, garlic, wheat, oats, barley (and other whole grains), flaxseed, tomatoes, Jerusalem artichoke, onions and chicory, greens (e.g., dandelion greens, spinach, collard greens, chard, kale, mustard greens, turnip greens), and legumes (e.g., lentils, kidney beans, chickpeas, navy beans, white beans, black beans). In some embodiments, the present composition is free or substantially free from prebiotics.

### Weight Management Agent

In certain embodiments, the functional ingredient is at least one weight management agent. As used herein, “a weight management agent” includes an appetite suppressant and/or a thermogenesis agent. As used herein, the phrases “appetite suppressant”, “appetite satiation compositions”, “satiety agents”, and “satiety ingredients” are synonymous. The phrase “appetite suppressant” describes macronutrients, herbal extracts, exogenous hormones, anorectics, anorexigenics, pharmaceutical drugs, and combinations thereof, that when delivered in an effective amount, suppress, inhibit, reduce, or otherwise curtail a person's appetite. The phrase “thermogenesis agent” describes macronutrients, herbal extracts, exogenous hormones, anorectics, anorexigenics, pharmaceutical drugs, and combinations thereof, that when delivered in an effective amount, activate or otherwise enhance a person's thermogenesis or metabolism.

Suitable weight management agents include macronutrients selected from the group consisting of proteins, carbohydrates, dietary fats, and combinations thereof. Consumption of proteins, carbohydrates, and dietary fats stimulates the release of peptides with appetite suppressing effects. For example, consumption of proteins and dietary fats stimulates the release of the gut hormone cholecytokinin (CCK), while consumption of carbohydrates and dietary fats stimulates release of Glucagon-like peptide 1 (GLP-1).

Suitable macronutrient weight management agents also include carbohydrates. Carbohydrates generally comprise sugars, starches, cellulose and gums that the body converts into glucose for energy. Carbohydrates often are classified into two categories, digestible carbohydrates (e.g., monosaccharides, disaccharides, and starch) and non-digestible carbohydrates (e.g., dietary fiber). Studies have shown that non-digestible carbohydrates and complex polymeric carbohydrates having reduced absorption and digestibility in the small intestine stimulate physiologic responses that inhibit food intake. Accordingly, the carbohydrates embodied herein desirably comprise non-digestible carbohydrates or carbohydrates with reduced digestibility. Non-limiting examples of such carbohydrates include polydextrose; inulin; monosaccharide-derived polyols such as erythritol, mannitol, xylitol, and sorbitol; disaccharide-derived alcohols such as isomalt, lactitol, and maltitol; and hydrogenated starch hydrolysates. Carbohydrates are described in more detail herein below.

### Dietary Fat

In another particular embodiment, the weight management agent is a dietary fat. Dietary fats are lipids comprising combinations of saturated and unsaturated fatty acids. Polyunsaturated fatty acids have been shown to have a greater satiating power than mono-unsaturated fatty acids. Accordingly, the dietary fats embodied herein desirably comprise poly-unsaturated fatty acids, non-limiting examples of which include triacylglycerols. In another particular embodiment, the weight management agent is an herbal extract. Extracts from numerous types of plants have been identified as possessing appetite suppressant properties. Non-limiting examples of plants whose extracts have appetite suppressant properties include plants of the genus Hoodia, Trichocaulon, Caralluma, Stapelia, Orbea, Asclepias, and Camelia. Other embodiments include extracts derived from Gymnema sylvestre, Kola Nut, Citrus Auran tium, Yerba Mate, Griffonia simplicifolia, Guarana, myrrh, guggul Lipid, and black current seed oil.

In another embodiment, the weight management agent is a pharmaceutical drug. Non limiting examples include phentenime, diethylpropion, phendimetrazine, sibutramine, rimonabant, oxyntomodulin, floxetine hydrochloride, ephedrine, phenethylamine, or other stimulants.

### Herbal Extracts

The herbal extracts may be prepared from any type of plant material or plant biomass. Non-limiting examples of plant material and biomass include the stems, roots, leaves, dried powder obtained from the plant material, and sap or dried sap. The herbal extracts generally are prepared by extracting sap from the plant and then spray-drying the sap. Alternatively, solvent extraction procedures may be employed. Following the initial extraction, it may be desirable to further fractionate the initial extract (e.g., by column chromatography) in order to obtain an herbal extract with enhanced activity. Such techniques are well known to those of ordinary skill in the art.

In one embodiment, the herbal extract is derived from a plant of the genus Hoodia. A sterol glycoside of Hoodia, known as P57, is believed to be responsible for the appetite-suppressant effect of the Hoodia species. In another embodiment, the herbal extract is derived from a plant of the genus Caralluma, non-limiting examples of which include caratuberside A, caratuberside B, bouceroside I, bouceroside II, bouceroside III, bouceroside IV, bouceroside V, bouceroside VI, bouceroside VII, bouceroside VIII, bouceroside IX, and bouceroside X. In another embodiment, the at least one herbal extract is derived from a plant of the genus Trichocaulon. Trichocaulon plants are succulents that generally are native to southern Africa, similar to Hoodia, and include the species T piliferum and T officinale. In another embodiment, the herbal extract is derived from a plant of the genus Stapelia or Orbea. Not wishing to be bound by any theory, it is believed that the compounds exhibiting appetite suppressant activity are saponins, such as pregnane glycosides, which include stavarosides A, B, C, D, E, F, G, H, I, J, and K. In another embodiment, the herbal extract is derived from a plant of the genus Asclepias. Not wishing to be bound by any theory, it is believed that the extracts comprise steroidal compounds, such as pregnane glycosides and pregnane aglycone, having appetite suppressant effects. In another particular embodiment, the weight management agent is an exogenous hormone having a weight management effect. Non-limiting examples of such hormones include CCK, peptide YY, ghrelin, bombesin and gastrin-releasing peptide (GRP), enterostatin, apolipoprotein A-IV, GLP-1, amylin, somastatin, and leptin.

### Osteoporosis Management Agent

In certain embodiments, the functional ingredient is at least one osteoporosis management agent. In certain embodiments, the osteoporosis management agent is at least one calcium source. According to a particular embodiment, the calcium source is any compound containing calcium, including salt complexes, solubilized species, and other forms of calcium. Non-limiting examples of calcium sources include amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium citrate malate, calcium gluconate, calcium tartrate, calcium lactate, solubilized species thereof, and

According to a particular embodiment, the osteoporosis management agent is a magnesium source. The magnesium source is any compound containing magnesium, including salt complexes, solubilized species, and other forms of magnesium. Non-limiting examples of magnesium sources include magnesium chloride, magnesium citrate, magnesium gluceptate, magnesium gluconate, magnesium lactate, magnesium hydroxide, magnesium picolate, magnesium sulfate, solubilized species thereof, and mixtures thereof. In another particular embodiment, the magnesium source comprises an amino acid chelated or amino acid formulation chelated magnesium.

In other embodiments, the osteoporosis agent is chosen from vitamins D, C, K, their precursors and/or beta-carotene and combinations thereof.

Numerous plants and plant extracts also have been identified as being effective in the prevention and treatment of osteoporosis. Non-limiting examples of suitable plants and plant extracts as osteoporosis management agents include species of the genus Taraxacum and Amelanchier, as disclosed in U.S. Patent Publication No. 2005/0106215, and species of the genus Lindera, Artemisia, Acorus, Carthamus, Carum, Cnidium, Curcuma, Cyperus, Juniperus, Prunus, Iris, Cichorium, Dodonaea, Epimedium, Erigonoum, rioya, Mentha, Ocimum, thymus, Tanacetum, Plantago, Spearmint, Bixa, Vitis, Rosemarinus, Rhus, and Anethum, as disclosed in U.S. Pat. App. No. 2005/0079232.

### Phytoestrogen

In certain embodiments, the functional ingredient is at least one phytoestrogen. Phytoestrogens are compounds found in plants which can typically be delivered into human bodies by ingestion of the plants or the plant parts having the phytoestrogens. As used herein, “phytoestrogen” refers to any substance which, when introduced into a body causes an estrogen like effect of any degree. For example, a phytoestrogen may bind to estrogen receptors within the body and have a small estrogen-like effect.

Examples of suitable phytoestrogens for embodiments of this disclosure include, but are not limited to, isoflavones, stilbenes, lignans, resorcyclic acid lactones, coumestans, coumestrol, equol, and combinations thereof. Sources of suitable phytoestrogens include, but are not limited to, whole grains, cereals, fibers, fruits, vegetables, black cohosh, agave root, black currant, black haw, chasteberries, cramp bark, dong quai root, devil's club root, false unicorn root, ginseng root, groundsel herb, licorice, liferoot herb, motherwort herb, peony root, raspberry leaves, rose family plants, sage leaves, sarsaparilla root, saw palmetto berried, wild yam root, yarrow blossoms, legumes, soy beans, soy products (e.g., miso, soy flour, soymilk, soy nuts, soy protein isolate, tempen, or tofu) chick peas, nuts, lentils, seeds, clover, red clover, dandelion leaves, dandelion roots, fenugreek seeds, green tea, hops, red wine, flaxseed, garlic, onions, linseed, borage, butterfly weed, caraway, chaste tree, vitex, dates, dill, fennel seed, gotu kola, milk thistle, pennyroyal, pomegranates, southernwood, soya flour, tansy, and root of the kudzu vine (pueraria root) and the like, and combinations thereof.

Isoflavones belong to the group of polyphenols as described supra. Suitable phytoestrogen isoflavones in accordance with embodiments of this disclosure include genistein, daidzein, glycitein, biochanin A, formononetin, their respective naturally occurring glycosides and glycoside conjugates, matairesinol, secoisolariciresinol, enter olactone, enterodiol, textured vegetable protein, and combinations thereof. Suitable sources of isoflavones for embodiments of this disclosure include, but are not limited to, soy beans, soy products, legumes, alfalfa sprouts, chickpeas, peanuts, and red clover.

### Long Chain Primary Aliphatic Saturated Alcohol

In certain embodiments, the functional ingredient is at least one long chain primary aliphatic saturated alcohol. Long-chain primary aliphatic saturated alcohols are a diverse group of organic compounds. The term alcohol refers to the fact these compounds feature a hydroxyl group (—OH) bound to a carbon atom. Non-limiting examples of particular long-chain primary aliphatic saturated alcohols for use in particular embodiments of the disclosure include the 8 carbon atom 1-octanol, the 9 carbon 1-nonanol, the 10 carbon atom 1-decanol, the 12 carbon atom 1-dodecanol, the 14 carbon atom 1-tetradecanol, the 16 carbon atom 1-hexadecanol, the 18 carbon atom 1-octadecanol, the 20 carbon atom 1-eicosanol, the 22 carbon 1-docosanol, the 24 carbon 1-tetracosanol, the 26 carbon 1-hexacosanol, the 27 carbon 1-heptacosanol, the 28 carbon 1-octanosol, the 29 carbon 1-nonacosanol, the 30 carbon 1-triacontanol, the 32 carbon 1-dotriacontanol, and the 34 carbon 1-tetracontanol.

In one embodiment, the long-chain primary aliphatic saturated alcohol is a policosanol. Policosanol is the term for a mixture of long-chain primary aliphatic saturated alcohols composed primarily of 28 carbon 1-octanosol and 30 carbon 1-triacontanol, as well as other alcohols in lower concentrations such as 22 carbon 1-docosanol, 24 carbon 1-tetracosanol, 26 carbon 1-hexacosanol, 27 carbon 1-heptacosanol, 29 carbon 1-nonacosanol, 32 carbon 1-dotriacontanol, and 34 carbon 1-tetracontanol.

In certain embodiments, the functional ingredient is at least one phytosterol, phytostanol or combination thereof. As used herein, the phrases “stand”, “plant stand” and “phytostanol” are synonymous. Plant sterols and stands are present naturally in small quantities in many fruits, vegetables, nuts, seeds, cereals, legumes, vegetable oils, bark of the trees and other plant sources. Sterols are a subgroup of steroids with a hydroxyl group at C-3. Generally, phytosterols have a double bond within the steroid nucleus, like cholesterol; however, phytosterols also may comprise a substituted side Chain® at C-24, such as an ethyl or methyl group, or an additional double bond. The structures of phytosterols are well known to those of skill in the art.

At least 44 naturally-occurring phytosterols have been discovered, and generally are derived from plants, such as corn, soy, wheat, and wood oils; however, they also may be produced synthetically to form compositions identical to those in nature or having properties similar to those of naturally-occurring phytosterols. Non-limiting suitable phytosterols include, but are not limited to, 4-desmethylsterols (e.g., b-sitosterol, campesterol, stigmasterol, brassicasterol, 22-dehydrobrassicasterol, and A5-avenasterol), 4-monomethyl sterols, and 4,4-dimethyl sterols (triterpene alcohols) (e.g., cycloartenol, 24-methylenecycloartanol, and cyclobranol).

As used herein, the phrases “stanol”, “plant stand” and “phytostanol” are synonymous. Phytostanols are saturated sterol alcohols present in only trace amounts in nature and also may be synthetically produced, such as by hydrogenation of phytosterols. Suitable phytostanols include, but are not limited to, b-sitostanol, campestanol, cycloartanol, and saturated forms of other triterpene alcohols.

Both phytosterols and phytostanols, as used herein, include the various isomers such as the a and b isomers. The phytosterols and phytostanols of the present disclosure also may be in their ester form. Suitable methods for deriving the esters of phytosterols and phytostanols are well known to those of ordinary skill in the art, and are disclosed in U.S. Pat. Nos. 6,589,588, 6,635,774, 6,800,317, and U.S. Pat. App. No. 2003/0045473. Non limiting examples of suitable phytosterol and phytostanol esters include sitosterol acetate, sitosterol oleate, stigmasterol oleate, and their corresponding phytostanol esters. The phytosterols and phytostanols of the present disclosure also may include their derivatives.

### Other Additives

Exemplary additives include, but not limited to, carbohydrates, polyols, sugar acids and their corresponding salts, nucleotides, organic acids, inorganic acids, organic salts including organic acid salts and organic base salts, inorganic salts, bitter compounds, caffeine, flavorants and flavoring ingredients, astringent compounds, proteins or protein hydrolysates, surfactants, emulsifiers, plant extracts, flavonoids, alcohols, polymers and combinations thereof.

In one embodiment, the composition further comprises one or more polyols. The term “polyol”, as used herein, refers to a molecule that contains more than one hydroxyl group. A polyol may be a diol, triol, or a tetrad which contains 2, 3, and 4 hydroxyl groups respectively.

A polyol also may contain more than 4 hydroxyl groups, such as a pentad, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group. Non-limiting examples of polyols in some embodiments include maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect taste.

Suitable sugar acid additives include, but are not limited to, aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof.

Suitable nucleotide additives include, but are not limited to, inosine monophosphate (IMP), guanosine monophosphate (GMP), adenosine monophosphate (AMP), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable organic acid additives include any compound which comprises a —COOH moiety, such as, for example, C2-C30 carboxylic acids, substituted hydroxyl C2-C30 carboxylic acids, butyric acid (ethyl esters), substituted butyric acid (ethyl esters), benzoic acid, substituted benzoic acids (e.g. 2,4-dihydroxy benzoic acid), substituted cinnamic acids, hydroxyacids, substituted hydroxy benzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, amino acid formulation, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration. Suitable organic acid additive salts include, but are not limited to, sodium, calcium, potassium, and magnesium salts of all organic acids, such as salts of citric acid, malic acid, tartaric acid, fumaric acid, lactic acid (e.g., sodium lactate), alginic acid (e.g., sodium alginate), ascorbic acid (e.g., sodium ascorbate), benzoic acid (e.g., sodium benzoate or potassium benzoate), sorbic acid and adipic acid. The examples of the organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfmyl, sulfamyl, carboxalkoxy, carboxamido, phosphonyl, phosphinyl, phosphoryl, phosphino, thioester, thioether, anhydride, oximino, hydrazino, carbamyl, phosphor or phosphonato. In particular embodiments, the organic acid additive is present in the sweetener composition in an amount effective to provide a concentration from about 10 ppm to about 5,000 ppm when present in a consumable, such as, for example, a beverage.

Suitable inorganic acid additives include, but are not limited to, phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

Suitable bitter compound additives include, but are not limited to, caffeine, quinine, urea, bitter orange oil, naringin, quassia, and salts thereof.

Suitable flavorants and flavoring ingredient additives include, but are not limited to, vanillin, vanilla extract, mango extract, cinnamon, citrus, coconut, ginger, viridiflorol, almond, menthol (including menthol without mint), grape skin extract, and grape seed extract. “Flavorant” and “flavoring ingredient” are synonymous and can include natural or synthetic substances or combinations thereof. Flavorants also include any other substance which imparts flavor and may include natural or non-natural (synthetic) substances which are safe for human or animals when used in a generally accepted range. Non-limiting examples of proprietary flavorants include DOHLER™ Natural Flavoring Sweetness Enhancer K14323 (DOHLER™, Darmstadt, Germany), Symrise™ Natural Flavor Mask for Sweeteners 161453 and 164126 (SYMRISE™, Holzminden, Germany), Natural Advantage™ Bitterness Blockers 1, 2, 9 and 10 (Natural Advantage™, Freehold, New Jersey, U.S.A.), and SUCRAMASK™ (Creative Research Management, Stockton, California, U.S.A.). Suitable polymer additives include, but are not limited to, chitosan, pectin, pectic, pectinic, polyuronic, polygalacturonic acid, starch, food hydrocolloid or crude extracts thereof (e.g., gum acacia Senegal (FIBERGUM™), gum acacia seyal, carageenan), poly-L-lysine (e.g., poly-L-α-lysine or poly-L-ε-lysine), poly-L-ornithine (e.g., poly-L-α-ornithine or poly-L-ε-ornithine), polypropylene glycol, polyethylene glycol, poly(ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

Suitable protein or protein hydrolysate additives include, but are not limited to, bovine serum albumin (BSA), whey protein (including fractions or concentrates thereof such as 90% instant whey protein isolate, 34% whey protein, 50% hydrolyzed whey protein, and 80% whey protein concentrate), soluble rice protein, soy protein, protein isolates, protein hydrolysates, reaction products of protein hydrolysates, glycoproteins, and/or proteoglycans containing amino acids (e.g., glycine, alanine, serine, threonine, asparagine, glutamine, arginine, valine, isoleucine, leucine, norvaline, methionine, proline, tyrosine, hydroxyproline, and the like), collagen (e.g., gelatin), partially hydrolyzed collagen (e.g., hydrolyzed fish collagen), and collagen hydrolysates (e.g., porcine collagen hydrolysate).

Suitable surfactant additives include, but are not limited to, polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltrimethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and other emulsifiers, and the like.

Suitable flavonoid additives are classified as flavonols, flavones, flavanones, flavan-3-ols, isoflavones, or anthocyanidins. Non-limiting examples of flavonoid additives include, but are not limited to, catechins (e.g., green tea extracts such as Polyphenon™ 60, Polyphenon™ 30, and Polyphenon™ 25 (Mitsui Norin Co., Ltd., Japan), polyphenols, rutins (e.g., enzyme modified rutin Sanmelin™ AO (San-fi Gen F.F.I., Inc., Osaka, Japan)), neohesperidin, naringin, neohesperidin dihydrochalcone, and the like. Suitable alcohol additives include, but are not limited to, ethanol.

Suitable astringent compound additives include, but are not limited to, tannic acid, europium chloride (EuCl₃), gadolinium chloride (GdCl₃), terbium chloride (TbCl₃), alum, tannic acid, and polyphenols (e.g., tea polyphenols).

### Sources of Selected Ingredients

In general, the caffeine and polyphenol of the present composition can be derived from any sources either naturally or synthetically. In some embodiments, the caffeine and/or polyphenol introduced into the present composition are extracted from plants and present in relatively pure form. In other embodiments, the caffeine and/or polyphenol are from synthetic sources in food grade or equivalent thereof. Examples of methods for synthesizing, producing, extracting, purifying caffeine and/or polyphenol are generally known in the art.

Alternatively, the caffeine and/or polyphenol can be introduced into the present composition by incorporating a component that contains the desired amount of caffeine and/or polyphenol into the composition. The component containing caffein, polyphenol, or both includes but is not limited to coffee, tea, yerba mate, guayusa, yaupon, guarana, cocoa, kola, or any combination thereof.

In some embodiments, the present composition comprises a plant, or a part thereof, or a product thereof, or an extract or juice thereof, wherein the plant contains caffeine, or polyphenol, or both. Table 2 shows exemplary examples of plants having both caffeine and polyphenol.

TABLE 2
Exemplary examples of natural sources of both caffeine and polyphenol.

| Common | | | Type of |
|---|---|---|---|
| name | Genus species | Caffeine | polyphenol |
| Coffee | Coffea spp. (C. arabica, C. robusta, | ✓ | Chlorogenic acid |
| | C. canephora, C. dewevrei, C. | | and analogues |
| | eugeniodes C. excelsa, C. liberica, | | |
| | C. salvatrix etc.) | | |
| Tea | Camellia spp. (C. chinensis, etc.) | ✓ | Catechins, |
| | | | procyanidins |
| Yerba Mate, | Ilex spp. (I. paraguariensis, | ✓ | Chlorogenic acid |
| Guayusa, | I. guayusa, I. vomitoria, | | and analogues |
| Yaupon . . . | I. cortuna, etc.) | | |
| Guarana | Paullinia cupana, P. trifoliata, | ✓ | Catechins, |
| | P. crysan, P. sorbilis | | procyanidins |
| Cocoa, etc. | Theobroma cacao, T. grandiflorum | ✓ | Catechins, |
| | | | procyanidins |
| Kola | Cola spp. (C. acuminata, C. nitida, | ✓ | Catechins, |
| | etc.) | | procyanidins |

In some embodiments, the present composition comprises a coffee extract or coffee juice product, and wherein the polyphenol and/or the caffeine are all or substantially from the coffee extract or coffee juice product. In other embodiments, at least a portion of the polyphenol and/or at least a portion of the caffeine is not from the coffee extract or the coffee juice product.

### Coffee and Tea Products

In some embodiments, the present composition comprises a coffee product. Non-limiting examples of the coffee product include: coffee extract, concentrated coffee, dried coffee, soluble coffee, coffee oils, coffee aromas, dry green coffee extract, wet green coffee extract, pulverized coffee, ground coffee, roast coffee, roast and ground coffee, soluble coffee, or any combinations thereof.

In one particular embodiment, the present composition comprises a coffee fruit (also known as coffee berry or coffee cherry), or a part, a product, an extract, or a juice thereof. In some embodiments, the coffee fruit is selected from the group of Coffea arabica or derivative thereof, Coffea canephora or derivative thereof, or any combination thereof. Products of coffee fruit are a natural resource of both caffeine and phenolic acid including chlorogenic acid, caffeic acid, ferulic acid, isoferulic acid, dihydroferulic acid, quinic acid, or combinations thereof.

The products of coffee fruit used in the present composition include but are not limited to liquid coffee fruit extracts, dried coffee fruits, coffee fruit powders, from-concentrate coffee fruit juice, not-from-concentrate (non-concentrate) coffee fruit juice, whole pressed coffee berry juice. Examples of coffee fruit extracts and coffee fruit juices and methods of making the same can be found in WO2021055757, which is incorporated by reference here in its entirety.

In some embodiments, the composition of the present disclosure comprises a coffee juice product or a coffee extract product, wherein the coffee juice product or a coffee extract product comprises caffeine and/or a derivative thereof; and a polyphenol comprising chlorogenic acid, wherein the composition has a weight ratio of the total chlorogenic acid to the total caffeine from about 1:10 to about 10:1. In certain embodiments, the coffee juice product is a coffee berry juice. In some embodiments, the coffee extract product is a coffee berry extract.

In some embodiments, the present composition consists essentially of a coffee juice product or a coffee extract product, wherein the coffee juice product or a coffee extract product comprises caffeine and/or a derivative thereof; and a polyphenol comprising chlorogenic acid, wherein the composition has a weight ratio of the total chlorogenic acid to the total caffeine from about 1:10 to about 10:1.

In some embodiments, the coffee juice product has a caffeine content from about 160 mg/L to about 7,000 mg/L. In some embodiments, the coffee juice product has a chlorogenic acid (CGA) content of about 350 mg/L to about 24,000 mg/L.

In some embodiments, the present composition comprises a tea product selected from the group of: soluble tea product, tea extract, concentrated tea, dried tea, tea leaves, tea aromas, green tea extract, concentrated green tea extract, or any combinations thereof.

### Beverage

In some embodiments, the composition is a beverage selected from the group of non-carbonated beverage, carbonated beverage, juice beverage, fruit juice, coffee beverage, tea beverage, milk beverage, diary beverage, plant protein drink, plant-based beverage, sport drink, energy drink.

As used herein, a “beverage” is a ready-to-drink beverage. Suitable ready-to-drink beverages include carbonated and non-carbonated beverages. Carbonated beverages include, but are not limited to, soft drinks, cola, lemon-lime flavored sparkling beverage, orange flavored sparkling beverage, grape flavored sparkling beverage, strawberry flavored sparkling beverage, pineapple flavored sparkling beverage, ginger-ale, soft drinks, root beer and malt beverages.

Non-carbonated beverages include, but are not limited to fruit juice, fruit-flavored juice, juice drinks, nectars, vegetable juice, vegetable-flavored juice, sports drinks, energy drinks, protein drinks, enhanced water with vitamins, near water drinks (e.g., water with natural or synthetic flavorants), coconut water, tea type (e.g. black tea, green tea, red tea, oolong tea), coffee, cocoa drink, beverage containing milk components (e.g. milk beverages, coffee containing milk components, café au lait, milk tea, fruit milk beverages), beverages containing cereal extracts, smoothies and combinations thereof.

Beverages contain a liquid matrix, i.e. the basic ingredient in which the ingredients—including caffeine and polyphenol of the present disclosure—are dissolved. In one embodiment, the liquid matrix is water of beverage quality, such as, for example deionized water, distilled water, reverse osmosis water, carbon-treated water, purified water, demineralized water and combinations thereof, can be used. Additional suitable liquid matrices include, but are not limited to phosphoric acid, phosphate buffer, citric acid, citrate buffer and carbon-treated water.

In one embodiment, the beverage contains inclusions, i.e. pulp, seed, chunks, etc.

The beverage can further include additives including, but not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, caffeine, flavorants and flavoring ingredients, astringent compounds, proteins or protein hydrolysates, surfactants, emulsifiers, weighing agents, juice, dairy, cereal and other plant extracts, flavonoids, alcohols, polymers and combinations thereof. Any suitable additive described herein can be used.

The beverage can further contain one or more additives and/or functional ingredients, described supra. Functional ingredients include, but are not limited to, vitamins, minerals, antioxidants, preservatives, glucosamine, and combinations thereof. Any suitable functional ingredient described herein can be used.

It is contemplated that the pH of the beverage does not materially or adversely affect the cogitation/alertness enhancement. A non-limiting example of the pH range of the beverage may be from about 1.8 to about 10. A further example includes a pH range from about 2 to about 5. In a particular embodiment, the pH of beverage can be from about 2.5 to about 4.2. One of skill in the art will understand that the pH of the beverage can vary based on the type of beverage. Dairy beverages, for example, can have pHs greater than 4.2.

The titratable acidity of the beverage may, for example, range from about 0.01 wt % to about 1.0 wt % by weight of beverage.

In one embodiment, the sparkling beverage product has an acidity from about 0.01 wt % to about 1.0 wt % by weight of the beverage, such as, for example, from about 0.05 wt % to about 0.25 wt % by weight of beverage.

The carbonation of a sparkling beverage product has 0 to about 2% (w/w) of carbon dioxide or its equivalent, for example, from about 0.1 to about 1.0% (w/w).

The temperature of the beverage may, for example, range from about 4° C. to about 100° C., such as, for example, from about 4° C. to about 25° C.

The beverage can be a full-calorie beverage that has up to about 120 calories per 8 oz serving. The beverage can be a mid-calorie beverage that has up to about 60 calories per 8 oz serving. The beverage can be a low-calorie beverage that has up to about 40 calories per 8 oz serving. The beverage can be a zero-calorie that has less than about 5 calories per 8 oz. serving.

In some embodiments, the present disclosure relates to a beverage consisting of a coffee berry juice, the coffee berry juice comprising: from about 0.01 wt % to about 2 wt % of caffeine; and from about 0.01 wt % to about 2 wt % of a polyphenol, wherein the polyphenol is chlorogenic acid, wherein the coffee berry juice has a weight ratio of the chlorogenic acid to the caffeine from about 1:10 to about 10:1, or from about 1:8 to about 8:1, or from about 1:6 to about 6:1, or from about 1:4 to about 4:1, or from about 1:2 to about 2:1, or from about 1.5:1 to about 3:1.

### Edible Gel Mixes and Edible Gel Compositions

In one embodiment, the president composition is an edible gel or edible gel mix.

Edible gels are gels that can be eaten. A gel is a colloidal system in which a network of particles spans the volume of a liquid medium. Although gels mainly are composed of liquids, and thus exhibit densities similar to liquids, gels have the structural coherence of solids due to the network of particles that spans the liquid medium. For this reason, gels generally appear to be solid, jelly-like materials. Gels can be used in a number of applications. For example, gels can be used in foods, paints, and adhesives.

Non-limiting examples of edible gel compositions for use in particular embodiments include gel desserts, puddings, jellies, pastes, trifles, aspics, marshmallows, gummy candies, or the like. Edible gel mixes generally are powdered or granular solids to which a fluid may be added to form an edible gel composition. Non-limiting examples of fluids for use in particular embodiments include water, dairy fluids, dairy analogue fluids, juices, alcohol, alcoholic beverages, and combinations thereof. Non-limiting examples of dairy fluids which may be used in particular embodiments include milk, cultured milk, cream, fluid whey, and mixtures thereof. Non-limiting examples of dairy analogue fluids which may be used in particular embodiments include, for example, soy milk and non-dairy coffee whitener. Because edible gel products found in the marketplace typically are sweetened with sucrose, it is desirable to sweeten edible gels with an alternative sweetener in order provide a low-calorie or non-calorie alternative.

As used herein, the term “gelling ingredient” denotes any material that can form a colloidal system within a liquid medium. Non-limiting examples of gelling ingredients for use in particular embodiments include gelatin, alginate, carageenan, gum, pectin, konjac, agar, food acid, rennet, starch, starch derivatives, and combinations thereof. It is well known to those having ordinary skill in the art that the amount of gelling ingredient used in an edible gel mix or an edible gel composition varies considerably depending on a number of factors, such as the particular gelling ingredient used, the particular fluid base used, and the desired properties of the gel.

Non-limiting examples of other ingredients for use in particular embodiments include a food acid, a salt of a food acid, a buffering system, a bulking agent, a sequestrant, a cross-linking agent, one or more flavors, one or more colors, and combinations thereof. Non-limiting examples of food acids for use in particular embodiments include citric acid, adipic acid, fumaric acid, lactic acid, malic acid, and combinations thereof. Non-limiting examples of salts of food acids for use in particular embodiments include sodium salts of food acids, potassium salts of food acids, and combinations thereof. Non-limiting examples of bulking agents for use in particular embodiments include raftilose, isomalt, sorbitol, polydextrose, maltodextrin, and combinations thereof. Non-limiting examples of sequestrants for use in particular embodiments include calcium disodium ethylene tetra-acetate, glucono delta-lactone, sodium gluconate, potassium gluconate, ethylenediaminetetraacetic acid (EDTA), and combinations thereof. Non-limiting examples of cross-linking agents for use in particular embodiments include calcium ions, magnesium ions, sodium ions, and combinations thereof.

### Confections

In one embodiment, the present composition is a confection.

As referred to herein, “confection” can mean a sweet, a lollie, a confectionery, or similar term. The confection generally contains a base composition component and a sweetener component. The confection may be in the form of any food that is typically perceived to be rich in sugar or is typically sweet. According to particular embodiments of the present disclosure, the confections may be bakery products such as pastries; desserts such as yogurt, jellies, drinkable jellies, puddings, Bavarian cream, blancmange, cakes, brownies, mousse and the like, sweetened food products eaten at tea time or following meals; frozen foods; cold confections, e.g. types of ice cream such as ice cream, ice milk, lacto-ice and the like (food products in which sweeteners and various other types of raw materials are added to milk products, and the resulting mixture is agitated and frozen), and ice confections such as sherbets, dessert ices and the like (food products in which various other types of raw materials are added to a sugary liquid, and the resulting mixture is agitated and frozen); general confections, e.g., baked confections or steamed confections such as crackers, biscuits, buns with bean-jam filling, halvah, alfajor, and the like; rice cakes and snacks; table top products; general sugar confections such as chewing gum (e.g. including compositions which comprise a substantially water-insoluble, chewable gum base, such as chicle or substitutes thereof, including jetulong, guttakay rubber or certain comestible natural synthetic resins or waxes), hard candy, soft candy, mints, nougat candy, jelly beans, fudge, toffee, taffy, Swiss milk tablet, licorice candy, chocolates, gelatin candies, marshmallow, marzipan, divinity, cotton candy, and the like; sauces including fruit flavored sauces, chocolate sauces and the like; edible gels; crémes including butter cremes, flour pastes, whipped cream and the like; jams including strawberry jam, marmalade and the like; and breads including sweet breads and the like or other starch products, and combinations thereof.

As referred to herein, “base composition” means any composition which can be a food item and provides a matrix for carrying the sweetener component.

Suitable base compositions for embodiments of this disclosure may include flour, yeast, water, salt, butter, eggs, milk, milk powder, liquor, gelatin, nuts, chocolate, citric acid, tartaric acid, fumaric acid, natural flavors, artificial flavors, colorings, polyols, sorbitol, isomalt, maltitol, lactitol, malic acid, magnesium stearate, lecithin, hydrogenated glucose syrup, glycerine, natural or synthetic gum, starch, and the like, and combinations thereof. Such components generally are recognized as safe (GRAS) and/or are U.S. Food and Drug Administration (FDA)-approved. According to particular embodiments of the invention, the base composition is present in the confection in an amount ranging from about 0.1 to about 99 weight percent of the confection.

The base composition of the confection may optionally include other artificial or natural sweeteners, bulk sweeteners, or combinations thereof. Bulk sweeteners include both caloric and non-caloric compounds. Non-limiting examples of bulk sweeteners include sucrose, dextrose, maltose, dextrin, dried invert sugar, fructose, high fructose corn syrup, levulose, galactose, corn syrup solids, tagatose, polyols (e.g., sorbitol, mannitol, xylitol, lactitol, erythritol, and maltitol), hydrogenated starch hydrolysates, isomalt, trehalose, and mixtures thereof. Generally, the amount of bulk sweetener present in the confection ranges widely depending on the particular embodiment of the confection and the desired degree of sweetness. Those of ordinary skill in the art will readily ascertain the appropriate amount of bulk sweetener.

### Condiment Compositions

In one embodiment, the present composition is a condiment. In another embodiment, a condiment comprises a composition of the present disclosure. Condiments, as used herein, are compositions used to enhance or improve the flavor of a food or beverage. Non-limiting examples of condiments include ketchup (catsup); mustard; barbecue sauce; butter; chili sauce; chutney; cocktail sauce; curry; dips; fish sauce; horseradish; hot sauce; jellies, jams, marmalades, or preserves; mayonnaise; peanut butter; relish; remoulade; salad dressings (e.g., oil and vinegar, Caesar, French, ranch, bleu cheese, Russian, Thousand Island, Italian, and balsamic vinaigrette), salsa; sauerkraut; soy sauce; steak sauce; syrups; tartar sauce; and Worcestershire sauce.

Condiment bases generally comprise a mixture of different ingredients, non-limiting examples of which include vehicles (e.g., water and vinegar); spices or seasonings (e.g., salt, pepper, garlic, mustard seed, onion, paprika, turmeric, and combinations thereof); fruits, vegetables, or their products (e.g., tomatoes or tomato-based products (paste, puree), fruit juices, fruit juice peels, and combinations thereof); oils or oil emulsions, particularly vegetable oils; thickeners (e.g., xanthan gum, food starch, other hydrocolloids, and combinations thereof); and emulsifying agents (e.g., egg yolk solids, protein, gum arabic, carob bean gum, guar gum, gum karaya, gum tragacanth, carageenan, pectin, propylene glycol esters of alginic acid, sodium carboxy methyl-cellulose, polysorbates, and combinations thereof). Recipes for condiment bases and methods of making condiment bases are well known to those of ordinary skill in the art.

Generally, condiments also comprise caloric sweeteners, such as sucrose, high fructose corn syrup, molasses, honey, or brown sugar. In exemplary embodiments of the condiments provided herein, a compound of the present invention or a composition comprising the same is used instead of traditional caloric sweeteners. Accordingly, a condiment composition desirably comprises a compound of the present invention or a composition comprising a compound of the present invention and a condiment base.

The condiment composition optionally may include other natural and/or synthetic high-potency sweeteners, bulk sweeteners, pH modifying agents (e.g., lactic acid, citric acid, phosphoric acid, hydrochloric acid, acetic acid, and combinations thereof), fillers, functional agents (e.g., pharmaceutical agents, nutrients, or components of a food or plant), flavorings, colorings, or combinations thereof.

### Chewing Gum Compositions

In one embodiment, the present composition is a chewing gum. In another embodiment, a chewing gum composition comprises a composition of the present disclosure. Chewing gum compositions generally comprise a water-soluble portion and a water-insoluble chewable gum base portion. The water soluble portion, which typically includes the composition of the present disclosure, dissipates with a portion of the flavoring agent over a period of time during chewing while the insoluble gum base portion is retained in the mouth. The insoluble gum base generally determines whether a gum is considered chewing gum, bubble gum, or a functional gum.

The insoluble gum base, which is generally present in the chewing gum composition in an amount in the range of about 15 to about 35 weight percent of the chewing gum composition, generally comprises combinations of elastomers, softeners (plasticizers), emulsifiers, resins, and fillers. Such components generally are considered food grade, recognized as safe (GRA), and/or are U.S. Food and Drug Administration (FDA)-approved.

Elastomers, the primary component of the gum base, provide the rubbery, cohesive nature to gums and can include one or more natural rubbers (e.g., smoked latex, liquid latex, or guayule); natural gums (e.g., jelutong, perillo, sorva, massaranduba balata, massaranduba chocolate, nispero, rosindinha, chicle, and gutta hang kang); or synthetic elastomers (e.g., butadiene-styrene copolymers, isobutylene-isoprene copolymers, poly butadiene, polyisobutylene, and vinyl polymeric elastomers). In a particular embodiment, the elastomer is present in the gum base in an amount in the range of about 3 to about 50 weight percent of the gum base.

Resins are used to vary the firmness of the gum base and aid in softening the elastomer component of the gum base. Non-limiting examples of suitable resins include a rosin ester, a terpene resin (e.g., a terpene resin from α-pinene, β-pinene and/or d-limonene), polyvinyl acetate, polyvinyl alcohol, ethylene vinyl acetate, and vinyl acetate-vinyl laurate copolymers. Non-limiting examples of rosin esters include a glycerol ester of a partially hydrogenated rosin, a glycerol ester of a polymerized rosin, a glycerol ester of a partially dimerized rosin, a glycerol ester of rosin, a pentaerythritol ester of a partially hydrogenated rosin, a methyl ester of rosin, or a methyl ester of a partially hydrogenated rosin. In a particular embodiment, the resin is present in the gum base in an amount in the range of about 5 to about 75 weight percent of the gum base.

Softeners, which also are known as plasticizers, are used to modify the ease of chewing and/or mouth feel of the chewing gum composition. Generally, softeners comprise oils, fats, waxes, and emulsifiers. Non-limiting examples of oils and fats include tallow; hydrogenated tallow, large, hydrogenated or partially hydrogenated vegetable oils (e.g., soybean, canola, cottonseed, sunflower, palm, coconut, corn, safflower, or palm kernel oils), cocoa butter, glycerol monostearate, glycerol triacetate, glycerol abietate, leithin, monoglycerides, diglycerides, triglycerides acetylated monoglycerides, and free fatty acids. Non-limiting examples of waxes include polypropylene/polyethylene/Fisher-Tropsch waxes, paraffin, and microcrystalline and natural waxes (e.g., candelilla, beeswax and carnauba). Microcrystalline waxes, especially those with a high degree of crystallinity and a high melting point, also may be considered as bodying agents or textural modifiers. In a particular embodiment, the softeners are present in the gum base in an amount in the range of about 0.5 to about 25 weight percent of the gum base.

Emulsifiers are used to form a uniform dispersion of the insoluble and soluble phases of the chewing gum composition and also have plasticizing properties. Suitable emulsifiers include glycerol monostearate (GMS), lecithin (Phosphatidyl choline), polyglycerol polyricinoleic acid (PPGR), mono and diglycerides of fatty acids, glycerol distearate, tracetin, acetylated monoglyceride, glycerol triactetate, and magnesium stearate. In a particular embodiment, the emulsifiers are present in the gum base in an amount in the range of about 2 to about 30 weight percent of the gum base.

The chewing gum composition also may comprise adjuvants or fillers in either the gum base and/or the soluble portion of the chewing gum composition. Suitable adjuvants and fillers include lecithin, inulin, polydextrin, calcium carbonate, magnesium carbonate, magnesium silicate, ground limestome, aluminum hydroxide, aluminum silicate, talc, clay, alumina, titanium dioxide, and calcium phosphate. In particular embodiments, lecithin can be used as an inert filler to decrease the stickiness of the chewing gum composition. In other particular embodiments, lactic acid copolymers, proteins (e.g., gluten and/or zein) and/or guar can be used to create a gum that is more readily biodegradable. The adjuvants or fillers are generally present in the gum base in an amount up to about 20 weight percent of the gum base. Other optional ingredients include coloring agents, whiteners, preservatives, and flavors.

In particular embodiments of the chewing gum composition, the gum base comprises about 5 to about 95 weight percent of the chewing gum composition, more desirably about 15 to about 50 weight percent of the chewing gum composition, and even more desirably from about 20 to about 30 weight percent of the chewing gum composition.

The soluble portion of the chewing gum composition may optionally include other artificial or natural sweeteners, bulk sweeteners, softeners, emulsifiers, flavoring agents, coloring agents, adjuvants, fillers, functional agents (e.g., pharmaceutical agents or nutrients), or combinations thereof. Suitable examples of softeners and emulsifiers are described above.

Bulk sweeteners include both caloric and non-caloric compounds. Non-limiting examples of bulk sweeteners include sucrose, dextrose, maltose, dextrin, dried invert sugar, fructose, high fructose corn syrup, levulose, galactose, corn syrup solids, tagatose, polyols (e.g., sorbitol, mannitol, xylitol, lactitol, erythritol, and maltitol), hydrogenated starch hydrolysates, isomalt, trehalose, and mixtures thereof. In particular embodiments, the bulk sweetener is present in the chewing gum composition in an amount in the range of about 1 to about 75 weight percent of the chewing gum composition.

Flavoring agents may be used in either the insoluble gum base or soluble portion of the chewing gum composition. Such flavoring agents may be natural or artificial flavors. In a particular embodiment, the flavoring agent comprises an essential oil, such as an oil derived from a plant or a fruit, peppermint oil, spearmint oil, other mint oils, clove oil, cinnamon oil, oil of wintergreen, bay, thyme, cedar leaf, nutmeg, allspice, sage, mace, and almonds. In another particular embodiment, the flavoring agent comprises a plant extract or a fruit essence such as apple, banana, watermelon, pear, peach, grape, strawberry, raspberry, cherry, plum, pineapple, apricot, and mixtures thereof. In still another particular embodiment, the flavoring agent comprises a citrus flavor, such as an extract, essence, or oil of lemon, lime, orange, tangerine, grapefruit, citron, or kumquat.

### Cereal Compositions

In one embodiment, the present composition is a cereal composition. In another embodiment, the present disclosure relates to a cereal composition that comprises a composition comprising caffeine and polyphenol. Cereal compositions typically are eaten either as staple foods or as snacks. Non-limiting examples of cereal compositions for use in particular embodiments include ready-to-eat cereals as well as hot cereals. Ready-to-eat cereals are cereals which may be eaten without further processing (i.e. cooking) by the consumer. Examples of ready-to-eat cereals include breakfast cereals and snack bars. Breakfast cereals typically are processed to produce a shredded, flaky, puffy, or extruded form. Breakfast cereals generally are eaten cold and are often mixed with milk and/or fruit. Snack bars include, for example, energy bars, rice cakes, granola bars, and nutritional bars. Hot cereals generally are cooked, usually in either milk or water, before being eaten. Non-limiting examples of hot cereals include grits, porridge, polenta, rice, and rolled oats.

Cereal compositions generally comprise at least one cereal ingredient. As used herein, the term “cereal ingredient” denotes materials such as whole or part grains, whole or part seeds, and whole or part grass. Non-limiting examples of cereal ingredients for use in particular embodiments include maize, wheat, rice, barley, bran, bran endosperm, bulgur, soghums, millets, oats, rye, triticale, buckwheat, fonio, quinoa, bean, soy bean, amaranth, teff, spelt, and kaniwa.

In a particular embodiment, the cereal composition comprises caffeine and polyphenol according to the present disclosure or a composition comprising caffeine and polyphenol and at least one cereal ingredient. Caffeine and polyphenol or the composition comprising caffeine and polyphenol may be added to the cereal composition in a variety of ways, such as, for example, as a coating, as a frosting, as a glaze, or as a matrix blend (i.e. added as an ingredient to the cereal formulation prior to the preparation of the final cereal product).

Accordingly, in a particular embodiment, caffeine and polyphenol or a composition comprising caffeine and polyphenol is added to the cereal composition as a matrix blend. In one embodiment, caffeine and polyphenol or a composition comprising caffeine and polyphenol are blended with a cereal prior to cooking to provide a cereal product. In another embodiment, caffeine and polyphenol or a composition comprising caffeine and polyphenol are blended with the cereal matrix before the cereal is extruded.

In another particular embodiment, caffeine and polyphenol or a composition comprising a caffeine and polyphenol are added to the cereal composition as a coating, such as, for example, by combining caffeine and polyphenol or a comprising caffeine and polyphenol with a food grade oil and applying the mixture onto the cereal. In a different embodiment, caffeine and polyphenol or a composition comprising caffeine and polyphenol and the food grade oil may be applied to the cereal separately, by applying either the oil or the sweetener first. Non-limiting examples of food grade oils for use in particular embodiments include vegetable oils such as corn oil, soybean oil, cottonseed oil, peanut oil, coconut oil, canola oil, olive oil, sesame seed oil, palm oil, palm kernel oil, and mixtures thereof. In yet another embodiment, food grade fats may be used in place of the oils, provided that the fat is melted prior to applying the fat onto the cereal.

In another embodiment, caffeine and polyphenol or a composition comprising caffeine and polyphenol are added to the cereal composition as a glaze. Non-limiting examples of glazing agents for use in particular embodiments include corn syrup, honey syrups and honey syrup solids, maple syrups and maple syrup solids, sucrose, isomalt, polydextrose, polyols, hydrogenated starch hydrolysate, aqueous solutions thereof, and mixtures thereof. In another such embodiment, caffeine and polyphenol or a composition comprising caffeine and polyphenol are added as a glaze by combining with a glazing agent and a food grade oil or fat and applying the mixture to the cereal. In yet another embodiment, a gum system, such as, for example, gum acacia, carboxymethyl cellulose, or algin, may be added to the glaze to provide structural support. In addition, the glaze also may include a coloring agent, and also may include a flavor.

In another embodiment, caffeine and polyphenol or a composition comprising caffeine and polyphenol is added to the cereal composition as a frosting. In one such embodiment, caffeine and polyphenol or a composition comprising caffeine and polyphenol is combined with water and a frosting agent and then applied to the cereal. Non-limiting examples of frosting agents for use in particular embodiments include maltodextrin, sucrose, starch, polyols, and mixtures thereof. The frosting also may include a food grade oil, a food grade fat, a coloring agent, and/or a flavor.

### Dairy Products

In one embodiment, the composition of the present disclosure is a dairy product that comprises caffeine and polyphenol described herein. In another embodiment, the composition of the present disclosure is a dairy product that comprises a composition comprising caffeine and polyphenol. Dairy products and processes for making dairy products suitable for use in this invention are well known to those of ordinary skill in the art. Dairy products, as used herein, comprise milk or foodstuffs produced from milk. Non-limiting examples of dairy products suitable for use in embodiments of this invention include milk, milk cream, sour cream, creme fraiche, buttermilk, cultured buttermilk, milk powder, condensed milk, evaporated milk, butter, cheese, cottage cheese, cream cheese, yogurt, ice cream, frozen custard, frozen yogurt, gelato, via, piima, filmjlk, kajmak, kephir, viili, kumiss, airag, ice milk, casein, ayran, lassi, khoa, or combinations thereof.

Milk is a fluid secreted by the mammary glands of female mammals for the nourishment of their young. The female ability to produce milk is one of the defining characteristics of mammals and provides the primary source of nutrition for newborns before they are able to digest more diverse foods. In particular embodiments of this invention, the dairy products are derived from the raw milk of cows, goats, sheep, horses, donkeys, camels, water buffalo, yaks, reindeer, moose, or humans.

In particular embodiments of this invention, the processing of the dairy product from raw milk generally comprises the steps of pasteurizing, creaming, and homogenizing. Although raw milk may be consumed without pasteurization, it usually is pasteurized to destroy harmful microorganisms such as bacteria, viruses, protozoa, molds, and yeasts. Pasteurizing generally comprises heating the milk to a high temperature for a short period of time to substantially reduce the number of microorganisms, thereby reducing the risk of disease.

Creaming traditionally follows pasteurization step, and involves the separation of milk into a higher-fat cream layer and a lower-fat milk layer. Milk will separate into milk and cream layers upon standing for twelve to twenty-four hours. The cream rises to the top of the milk layer and may be skimmed and used as a separate dairy product. Alternatively, centrifuges may be used to separate the cream from the milk. The remaining milk is classified according to the fat content of the milk, non-limiting examples of which include whole, 2%, 1%, and skim milk.

After removing the desired amount of fat from the milk by creaming, milk is often homogenized. Homogenization prevents cream from separating from the milk and generally involves pumping the milk at high pressures through narrow tubes in order to break up fat globules in the milk. Pasteurization, creaming, and homogenization of milk are common but are not required to produce consumable dairy products. Accordingly, suitable dairy products for use in embodiments of this invention may undergo no processing steps, a single processing step, or combinations of the processing steps described herein. Suitable dairy products for use in embodiments of this invention may also undergo processing steps in addition to or apart from the processing steps described herein.

Particular embodiments of this invention comprise dairy products produced from milk by additional processing steps. As described above, cream may be skimmed from the top of milk or separated from the milk using machine-centrifuges. In a particular embodiment, the dairy product comprises sour cream, a dairy product rich in fats that is obtained by fermenting cream using a bacterial culture. The bacteria produce lactic acid during fermentation, which sours and thickens the cream. In another particular embodiment, the dairy product comprises creme fraiche, a heavy cream slightly soured with bacterial culture in a similar manner to sour cream. Crème fraiche ordinarily is not as thick or as sour as sour cream. In yet another particular embodiment, the dairy product comprises cultured buttermilk. Cultured buttermilk is obtained by adding bacteria to milk. The resulting fermentation, in which the bacterial culture turns lactose into lactic acid, gives cultured buttermilk a sour taste. Although it is produced in a different manner, cultured buttermilk generally is similar to traditional buttermilk, which is a by-product of butter manufacture.

According to other particular embodiments of this invention, the dairy products comprise milk powder, condensed milk, evaporated milk, or combinations thereof. Milk powder, condensed milk, and evaporated milk generally are produced by removing water from milk. In a particular embodiment, the dairy product comprises a milk powder comprising dried milk solids with a low moisture content. In another particular embodiment, the dairy product comprises condensed milk. Condensed milk generally comprises milk with a reduced water content and added sweetener, yielding a thick, sweet product with a long shelf-life. In yet another particular embodiment, the dairy product comprises evaporated milk. Evaporated milk generally comprises fresh, homogenized milk from which about 60% of the water has been removed, that has been chilled, fortified with additives such as vitamins and stabilizers, packaged, and finally sterilized. According to another particular embodiment of this invention, the dairy product comprises a dry creamer and caffeine and polyphenol or a composition comprising caffeine and polyphenol.

In another particular embodiment, the dairy product provided herein comprises butter. Butter generally is made by churning fresh or fermented cream or milk. Butter generally comprises butterfat surrounding small droplets comprising mostly water and milk proteins. The churning process damages the membranes surrounding the microscopic globules of butterfat, allowing the milk fats to conjoin and to separate from the other parts of the cream. In yet another particular embodiment, the dairy product comprises buttermilk, which is the sour-tasting liquid remaining after producing butter from full-cream milk by the churning process.

In still another particular embodiment, the dairy product comprises cheese, a solid foodstuff produced by curdling milk using a combination of rennet or rennet substitutes and acidification. Rennet, a natural complex of enzymes produced in mammalian stomachs to digest milk, is used in cheese-making to curdle the milk, causing it to separate into solids known as curds and liquids known as whey. Generally, rennet is obtained from the stomachs of young ruminants, such as calves; however, alternative sources of rennet include some plants, microbial organisms, and genetically modified bacteria, fungus, or yeast. In addition, milk may be coagulated by adding acid, such as citric acid. Generally, a combination of rennet and/or acidification is used to curdle the milk. After separating the milk into curds and whey, some cheeses are made by simply draining, salting, and packaging the curds. For most cheeses, however, more processing is needed. Many different methods may be used to produce the hundreds of available varieties of cheese. Processing methods include heating the cheese, cutting it into small cubes to drain, salting, stretching, cheddaring, washing, molding, aging, and ripening. Some cheeses, such as the blue cheeses, have additional bacteria or molds introduced to them before or during aging, imparting flavor and aroma to the finished product. Cottage cheese is a cheese curd product with a mild flavor that is drained but not pressed so that some whey remains. The curd is usually washed to remove acidity. Cream cheese is a soft, mild-tasting, white cheese with a high fat content that is produced by adding cream to milk and then curdling to form a rich curd. Alternatively, cream cheese can be made from skim milk with cream added to the curd. It should be understood that cheese, as used herein, comprises all solid foodstuff produced by the curdling milk.

In another particular embodiment of this invention, the dairy product comprises yogurt. Yogurt generally is produced by the bacterial fermentation of milk. The fermentation of lactose produces lactic acid, which acts on proteins in milk to give the yogurt a gel-like texture and tartness. In particularly desirable embodiments, the yogurt may be sweetened with a sweetener and/or flavored. Non-limiting examples of flavorings include, but are not limited to, fruits (e.g., peach, strawberry, banana), vanilla, and chocolate. Yogurt, as used herein, also includes yogurt varieties with different consistencies and viscosities, such as dahi, dadih or dadiah, labneh or labaneh, bulgarian, kefir, and matsoni. In another particular embodiment, the dairy product comprises a yogurt-based beverage, also known as drinkable yogurt or a yogurt smoothie. In particularly desirable embodiments, the yogurt-based beverage may comprise sweeteners, flavorings, other ingredients, or combinations thereof.

Other dairy products beyond those described herein may be used in particular embodiments of this invention. Such dairy products are well known to those of ordinary skill in the art, non-limiting examples of which include milk, milk and juice, coffee, tea, via, piima, filmjolk, kajmak, kephir, viili, kumiss, airag, ice milk, casein, ayran, lassi, and khoa.

According to particular embodiments of this invention, the dairy compositions also may comprise other additives. Non-limiting examples of suitable additives include sweeteners and flavorants such as chocolate, strawberry, and banana. Particular embodiments of the dairy compositions provided herein also may comprise additional nutritional supplements such as vitamins (e.g., vitamin D) and minerals (e.g., calcium) to improve the nutritional composition of the milk.

In some embodiment, the present composition is a non-diary milk, a plant-based drink, a plant protein drink, a plant milk such as soy milk, almond milk, rice milk, soy bean milk, coconut milk, workpiece plant milk, and the like.

### Tabletop Functional Sweetener Compositions

In some embodiments, the present composition is a tabletop functional sweetener composition comprising caffeine and polyphenol in combination with: (i) at least one functional ingredient; (ii) at least one bulking agent; and (iii) optionally at least one sweet taste improving composition and/or anti-caking agent with improved temporal and/or flavor profile. In accordance with particular embodiments, suitable “bulking agents” include maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and the like, and mixtures thereof. Additionally, in accordance with still other embodiments of the invention, granulated sugar (sucrose) or other caloric sweeteners such as crystalline fructose, other carbohydrates, or sugar alcohols can be used as a bulking agent due to their provision of good content uniformity without the addition of significant calories. In one embodiment, a bulking agent may be used as a sweet taste improving composition.

As used herein the phrase “anti-caking agent” and “flow agent” refer to any composition which prevents, reduces, inhibits, or suppresses at least one natural and/or synthetic high-potency sweetener molecule from attaching, binding, or contacting to another natural and/or synthetic high-potency sweetener molecule. Alternatively, anti-caking agent may refer to any composition which assists in content uniformity and uniform dissolution. In accordance with particular embodiments, non-limiting examples of anti-caking agents include cream of tartar, calcium silicate, silicon dioxide, microcrystalline cellulose (Avicel, FMC BioPolymer, Philadelphia, Pa.), and tricalcium phosphate. In one embodiment, the anti-caking agents are present in the tabletop functional sweetener composition in an amount from about 0.001 to about 3% by weight of the tabletop functional sweetener composition.

Tabletop functional sweetener compositions are embodied and packaged in numerous different forms and it is intended that the tabletop functional sweetener compositions of the present invention may be of any form known in the art. In accordance with particular embodiments, non-limiting examples include powder form, granular form, packets, tablets, sachets, pellets, cubes, solids, and liquids.

In an embodiment, a tabletop functional sweetener composition comprises a single-serving (portion control) packet comprising a dry-blend of a functional sweetener formulation. Dry-blend formulations generally may comprise powder or granules. Although the tabletop functional sweetener packet may be of any size, an illustrative non-limiting example of conventional portion control tabletop sweetener packets are approximately 2.5 by 1.5 inches and hold approximately 1 gram of a sweetener composition having a sweetness equivalent to 2 teaspoons of granulated sugar (about 8 g). The amount of natural and/or synthetic high-potency sweetener in a dry-blend tabletop functional sweetener formulation will vary due to the varying potency of different natural and/or synthetic high-potency sweeteners. In a particular embodiment, a dry-blend tabletop functional sweetener formulation may comprise a natural and/or synthetic high-potency sweetener in an amount from about 1% (w/w) to about 10% (w/w) of the tabletop functional sweetener composition.

Solid tabletop functional sweetener embodiments include cubes and tablets. A non-limiting example of conventional cubes are equivalent in size to a standard cube of granulated sugar, which is approximately 2.2×2.2×2.2 cm³ and weigh approximately 8 g. In one embodiment, a solid tabletop sweetener is in the form of a tablet or any other four known to those skilled in the art.

In one embodiment, the tabletop functional sweetener composition may also be formulated for targeted uses, for example, in beverage, food, pharmaceutical, cosmetics, herbal/vitamins, tobacco, and in any other products which may be sweetened. For example, a tabletop functional sweetener composition for baking may be formulated having additional protecting agents such as encapsulants. Other forms will be readily apparent to those skilled in the tabletop sweetener art.

Commonly used methods for making powder or granulated functional sweetener formulations for packets include fluid bed agglomeration processes. Other methods for making tabletop sweetener compositions are well known to those of ordinary skill in the art.

### Methods

In another aspect, the present disclosure relates to a method for improving a condition of a human, the method comprising: administering to the human in need of an improved condition an edible composition described anywhere herein. In one particular embodiment, the composition comprises: caffeine and/or a derivative thereof; and a polyphenol, wherein the composition has a weight ratio of the total polyphenol to the total caffeine from about 1:10 to about 10:1. Improving the condition of the human includes but is not limited to improving cognitive function; reducing mental fatigue, improving alertness, reducing stress, improving tranquility, improving alertness, improving mental capability, improving memory capability, improving memory accuracy, improving mood, improving relaxation, reducing headache, improving/sustaining attention, improving sports performance, or any combinations thereof.

In some embodiments, the composition is administered orally by having the human ingest the composition. The composition may be administered at one time, or alternatively more than one time a day. The administration can continue for at least 1 day, at least 1 week, at least 1 month, at least 1 year. In some embodiments, the methods comprises applying a time interval between any two administrations per day, wherein the time interval is at least about 1 hour, at least about 2 hours, at least about 3 hours, at least about 4 hours, at least about 5 hours, or at least about 6 hours.

In some embodiments, the composition administered to the human has a dosage of caffeine of at least about 50 mg, at least about 75 mg, at least about 100 mg, or at least about 125 mg. In some embodiments, the composition administered to the human has a dosage of polyphenol of at least about 50 mg, at least about 75 mg, at least about 100 mg, at least about 125 mg, at least about 150 mg, at least about 200 mg, or at least about 250 mg. In some embodiments, the composition administered to the human has a dosage of chlorogenic acid of at least about 50 mg, at least about 75 mg, at least about 100 mg, at least about 125 mg, at least about 150 mg, at least about 200 mg, or at least about 250 mg.

In some embodiments, the present composition starts to take effect in improving the condition after a time period following the administration, wherein the time period is at least about 5 minutes, or at least about 15 minutes, or at least about 30 minutes, or at least about 60 minutes, or at least about 90 minutes, or at least about 120 minutes.

### NON-PATENT REFERENCES

Cropley, V., Croft, R., Silber, B., Neale, C., Scholey, A., Stough, C., Schmitt, J., Does coffee enriched with chlorogenic acids improve mood and cognition after acute administration in healthy elderly? A pilot study. Psychopharmacology, 2011, DOI 10.1007/s00213-011-2395-0.
Camfield, D. A., Silber, B. Y., Scholey, A. B., Nolidin, K., Goh, A., Stough, C., A randomised placebo-controlled trial to differentiate the acute cognitive and mood effects of chlorogenic acid from decaffeinated coffee. PLOS One, 2013, 8 (12):e82897.
Haskell-Ramsay, C. F., Jackson, P., Forster, J. S., Dodd, F. L., Bowerbank, S. L., and Kennedy, D. O., The Acute Effects of Caffeinated Black Coffee on Cognition and Mood in Healthy Young and Older Adults. Nutrients, 2018, 10, 1386.
Ward-Ritacco, C. L., Wilson, A. R., O'Connor, P. J., An Apple Extract Beverage Combined with Caffeine Can Improve Alertness, Mental Fatigue, and Information Processing Speed. Journal of Cognitive Enhancement, 2021, https://doi.org/10.1007/s41465-020-00204-1.
Reed. R. A., Mitchell, E. S., Saunders, C., and O'Connor, P., Acute Low and Moderate Doses of a Caffeine-Free Polyphenol-Rich Coffeeberry Extract Improve Feelings of Alertness and Fatigue Resulting from the Performance of Fatiguing Cognitive Tasks. Journal of Cognitive Enhancement, 2019, 3, 193-206.
Jackson, P., Wightman, E. L., Veasey, R., Forster, J., Khan, J., Saunders C., Mitchell. S., Haskell-Ramsay, C. F., Kennedy, D. O., A Randomized, Crossover Study of the Acute Cognitive and Cerebral Blood Flow Effects of Phenolic, Nitrate and Botanical Beverages in Young, Healthy Humans. Nutrients, 2020, 12 (8), 2254.
McGranahan, M., Nuccio, R., Mitchell, E., Pahnke, M., and O'Connor, P., Acute Effects of Two Doses of a Coffeeberry Extract on Mental Energy-Related Feelings and Cycling Performance After Cognitive and Physical Work. Current Developments in Nutrition, 2021, 5 (Supplemental 2), 1294.

All publications, patents and patent applications mentioned in the specification are indicative of the level of those skilled in the art to which this disclosure pertains.

The following examples illustrate preferred, but non-limiting embodiments of the present disclosure.

### EXAMPLES

Example 1—Study on acute effects of coffee berry juice on cognitive function and alertness in healthy adults.

### BACKGROUND

Chlorogenic acids, including caffeoylquinic acids, dicaffeoylquinic acids, feruloylquinic acids, and cumaroylquinic acids, have previously been shown to have cognition enhancing properties, including engendering improvements to attention and memory tasks, alongside reduced mental fatigue during difficult task performance. Caffeine has also been shown to increase alertness and improve the performance of attention tasks. Caffeine may also enjoy interactive relationships with many other bioactive compounds, including via competition with a number of structural groups of phytochemicals for access to the CYP450 enzymes that manage the body's relationship with endogenous and exogenous compounds.

Given the above, the combination of chlorogenic acids and caffeine may provide enhanced or additional benefits than caffeine itself. Several natural species, such as coffee and yerba mate, are natural sources of both caffeine and chlorogenic acids. This study will assess the effects of coffee berry juice which naturally contains caffeine and chlorogenic acids, in comparison to a placebo and/or positive (caffeine) controls, across a number of cognitive domains (attention, working memory, episodic memory, mood).

The constituents of the investigational products are not associated with any significant negative effects. There is therefore a low risk to balance against a significant benefit in terms of extending the knowledge of the efficacy of coffee berry juice.

### Objectives

The aim of the proposed randomized, double-blind, placebo-controlled, balanced cross-over methodology is to assess the acute effects of coffee berry juice on cognitive function and alertness. The trial utilized the Cognimapp, an online cognitive assessment system. The main cognitive/mood assessments will take place pre-dose and at 60 min post-dose on four separate testing days separated by a minimum of 1-day washout.

### Study Population

The study comprises a total of 32 (n=32 per condition) participants. Respondents were recruited by web survey using the inclusion and exclusion criteria.

The following criteria are used to selected participants for the study:
Participants are volunteering for the trials;
Participants must self-assess themselves as being in good health;
Aged 21 to 60 years at the time of giving consent;
Participants agree to stay engaged in the tasks across all tests, which can be identified from the dataset.

Participants are not eligible to take part if they:
Have any pre-existing medical condition/illness (e.g. feel sick, have reduced brain performance, such as focus, memory, accuracy, than usual) which will impact taking part in the study. (Note: participants may be allowed to attend if they have a condition/illness which would not interact with the active treatments or impede performance);
Have been diagnosed with or is undergoing treatment for a psychiatric disorder in the last 12 months;
Suffers from frequent migraines that require medication (more than or equal to 1 per month);
Have sleep disorders or are taking sleep aid medication;
Are pregnant, seeking to become pregnant or lactating;
Are currently taking prescription and over-the-counter (OTC) medications, especially contraceptive treatments for female participants, and those taken ‘as needed’ in the treatment of asthma (e.g. steroids) and hay fever (drowsy antihistamines only, e.g. chlorphenamine). (Note: There may be other instances of medication use where no interaction with the active treatments is likely, and which would not be expected to have any impact on brain function, participants may be able to attend the assessment);
Have taken antibiotics within the past 4 weeks (Note: participation is possible following a 4-week antibiotics washout prior to participating);
Smoke tobacco or vape nicotine or use nicotine replacement products
Have excessive caffeine intake (>500 mg per day), see CCQ;
Are self-evaluated to have difficulty in focusing on the tasks, e.g. too many meetings daily, etc.
Have a visual impairment that cannot be corrected with glasses or contact lenses (including color-blindness)
Refuse to consume the beverage containing artificial sweetener (e.g. aspartame, sucralose, acesulfame potassium, etc.).

### Example Beverages to be Evaluated for the Study

Three beverage product plus placebo are evaluated in the study. Table 3 shows the composition of the three beverage samples. Beverages products are non-commercialized carbonated beverage. All the ingredients are food grades and generally recognized as safe (GRAS) by FDA. The ingredients presented in the vehicle are at the same levels across all the products. Considering the study is double blinded, no ingredients information will be provided on the labels (under item “4.1.2”). Product label will read as follows; Sparkling Beverage, Code Number, Date of Manufacture, Not For Sale.

TABLE 3
Beverages used in the study

| | Beverage | Ingredients |
|---|---|---|
| Example | Non-concentrate | The sample contains caffeine |
| Beverage 1 | coffee berry juice | (0.2%, w/w), total caffeoylquinic |
| | | acids (0.3%, w/w), total |
| | | feruloylquinic acid (0.03%, w/w), |
| | | total dicaffeoylquinic acids |
| | | (0.02%, w/w), and vehicle. |
| | | One serving contains about 75 mg |
| | | of caffeine and about 131 mg of |
| | | total CGA. |
| Comparative | Caffeine-containing | One serving contains vehicle and |
| Beverage 1 | beverage | about 75 mg of caffeine without |
| | | CGA |
| Comparative | Caffeine-containing | One serving contains vehicle and |
| Beverage 2 | beverage | about 114 mg of caffeine without |
| | | CGA |
| Placebo | vehicle | One serving contains vehicle |
| | | without caffeine and CGA |

Participants are randomly allocated to a counterbalancing schedule dictating the order in which they receive the four interventions. An example of computerized counterbalancing schedule is given in Table 4.

TABLE 4
An example of counterbalancing schedule.

| ID | P1 | P2 | P3 | P4 |
|---|---|---|---|---|
| 101 | 1 | 3 | 4 | 2 |
| 102 | 4 | 1 | 2 | 3 |
| 103 | 1 | 3 | 2 | 4 |
| 104 | 2 | 3 | 1 | 4 |
| 105 | 2 | 4 | 3 | 1 |
| 106 | 3 | 1 | 2 | 4 |
| 107 | 3 | 1 | 4 | 2 |
| 108 | 3 | 4 | 2 | 1 |
| 109 | 3 | 2 | 1 | 4 |
| 110 | 4 | 3 | 2 | 1 |
| 111 | 2 | 4 | 3 | 1 |
| 112 | 2 | 3 | 4 | 1 |
| 113 | 3 | 2 | 1 | 4 |
| 114 | 2 | 1 | 3 | 4 |
| 115 | 1 | 4 | 2 | 3 |
| 116 | 1 | 3 | 4 | 2 |
| 117 | 3 | 2 | 1 | 4 |
| 118 | 1 | 3 | 4 | 2 |
| 119 | 3 | 4 | 1 | 2 |
| 120 | 4 | 1 | 2 | 3 |
| 121 | 1 | 2 | 3 | 4 |
| 122 | 2 | 4 | 3 | 1 |
| 123 | 4 | 3 | 1 | 2 |
| 124 | 4 | 2 | 3 | 1 |
| 125 | 2 | 1 | 4 | 3 |
| 126 | 4 | 2 | 1 | 3 |
| 127 | 4 | 1 | 2 | 3 |
| 128 | 2 | 4 | 1 | 3 |
| 129 | 1 | 2 | 4 | 3 |
| 130 | 4 | 1 | 3 | 2 |
| 131 | 3 | 2 | 4 | 1 |
| 132 | 1 | 4 | 3 | 2 |

Participants are instructed to consume one of the four interventions during each of their assessment days (Day 1/Day 2/Day 3/Day 4), with the order of the interventions counterbalanced across the participants (via random allocation to a counterbalancing schedule—example above).

A 3-digit code is assigned to each intervention. A computerized counterbalancing schedule is generated by a third-party who has no other involvement in the study. The beverages are prepared and pre-packaged in a GMP pilot plant by a third-party who has no other involvement in the study as well, according to the counterbalancing schedule. The packaging/label only shows “Sparkling Beverage, Code Number, Date of Manufacture, and Not For Sale”. The beverages are stored at 4° C. till the time of consumption.

The use of any prescribed medicinal products (with exceptions as per exclusion criteria) are not allowed during the trial, including OTC products.

### Observations

### Efficacy

This is intended as an exploratory placebo-controlled study investigating the acute effects of coffee berry juice on cognitive performance and alertness in comparison to placebo. The efficacy is assessed with respect to the investigational products' comparative (to placebo) effects following a single dose on the following measures:
Cognitive function—executive function, attention, working memory, long-term memory (pre-dose baseline and 60 min post-dose);
Cognitive function and mental fatigue during extended performance of cognitively demanding tasks (pre-dose baseline and 60 min post-dose);
Alertness, stress and tranquility, as assessed by the Visual Analogue Mood Scales (VAMS) at 60 min post-dose.

### Safety

All the products are manufactured in a GMP pilot plant and cleared with microbial tests.

The ingredients of the beverages are not associated with any significant deleterious adverse effects. Therefore, the proposed doses of coffee berry juice for the beverage product combination should be safe. There is no subject autonomy concern. However, participants are encouraged to report any unusual or adverse effects during the study.

### Investigation

The study follows a randomized, double-blind, placebo-controlled, balanced cross-over design.

During the study, participants attend an introductory/training session and four active testing days (Day 1, Day 2, Day 3, Day 4), with no less than 1 day (24 hours) wash-out time between testing days.

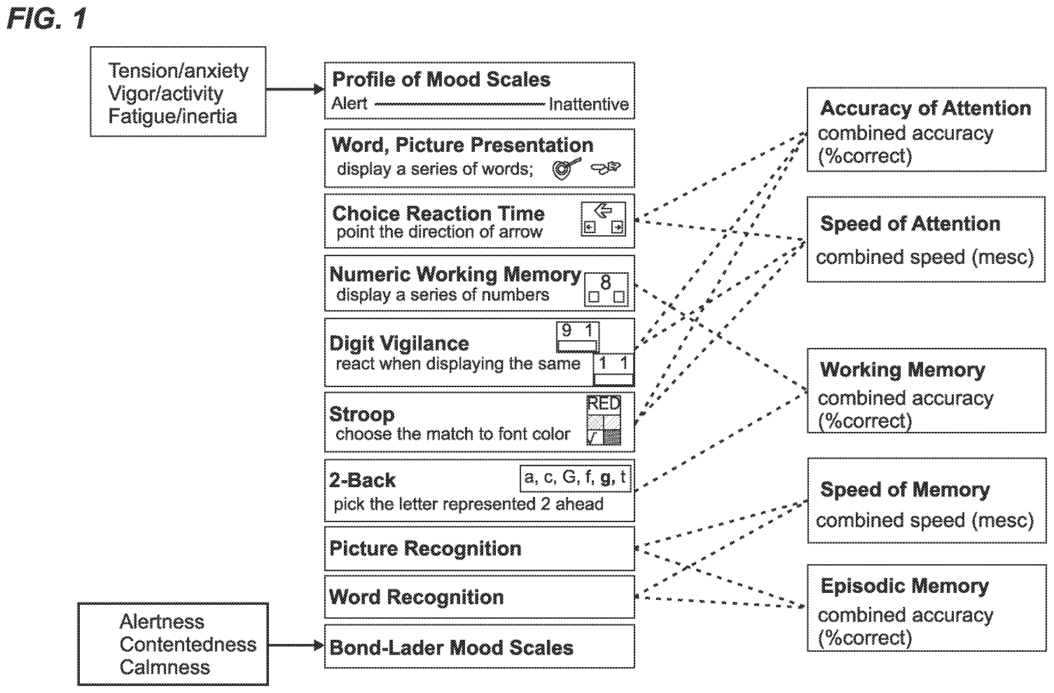

The Introductory session comprises the acquisition of Informed Consent Form (ICF), training and practice on the Cognimapp. The methodology on Days 1, 2, 3, and 4 are identical, with the exception that participants consume a different treatment during each testing day. On the testing day, participants are required to be abstained from alcohol (24 hr) and caffeine (18 hr). At least one hour after finishing the meal, participants are instructed to complete a 15-minute online cognitive and mood assessment on Cognimapp. An example of task assignment using Cognimapp is illustrated in FIG. 1. After the first cognitive assessment participants take their treatment (300 mL of beverage, be completed within 20 min) for the day and undergo cognitive/mood assessments identical to the above at 60 minutes post-dose. No additional food and drink other than water is allowed during assessments.

### Adherence to Protocol

An individual participant is to be withdrawn from the trial if:
The participant withdraws their consent, without need to justify the decision;
The participant no longer conforms to the inclusion/exclusion criteria;
The participant has to take any concomitant prescription drugs or any other substances the consumption of which would constitute grounds for exclusion (as per exclusion criteria) and the participant cannot be rescheduled;
The participant is no longer able to participate for other medical reasons (including adverse effects).

### Statistics

### Planned Analysis

Given that this is an exploratory investigation, with no existing data on which to base any predictions of treatment effects, no primary endpoints will be identified.

The intended analysis/analyses are applied to the following data (using pre-treatment data either to baseline adjust post-dose data.
Mood measures—Alertness, Stress, Tranquillity scores (pre-dose baseline and 60 min post-dose)
Cognitive function—Individual task parameters (pre-dose baseline and 60 min post-dose)
Cognitive function—composite cognitive factors (pre-dose baseline and 60 min post-dose)
Cognitive function and mental fatigue during extended performance of cognitively demanding tasks (pre-dose baseline and 60 min post-dose).

### Randomization

During the introductory visit participants are randomly allocated to receive their six treatments (as 3-digit product code) according to a blind counterbalancing schedule using a computer-generated random number list.

### Sample Size

The cross-over design and suggested sample size of 32 participants delivers good power (in excess of 90%) to detect the medium effect sizes seen previously with similar interventions. Power was calculated using G*Power 3.0.

### Results

A total of 26 (N=26) final data were received, after 6 participants drop out. Subjective measures of profile of mood scale and bond-lader mood scale were used to evaluate stress, vigorous, fatigue, alertness, contentedness, and calmness. The cognitive measures can be summarized as accuracy of attention, speed of attention, working memory, speed of memory, and episodic memory (FIG. 1). All the tasks listed in FIG. 1 produce multiple outcome measures.

Each cognitive function measure was analyzed using 60 min post-dose adjusted by pre-dose measurement as a covariate. The results provided evidence that coffee berry juice improved accuracy of attention, mood-vigorous, and accuracy of picture recognition. Example Beverage 1 (coffee berry juice having about 75 mg of caffeine and about 131 mg of total CGA) displayed a stronger pattern in observed cognitive benefits compared to Comparative Beverage 1 (beverage with about 75 mg of caffeine but no CGA) and Comparative Beverage 2 (beverage with about 114 mg of caffeine but no CGA).

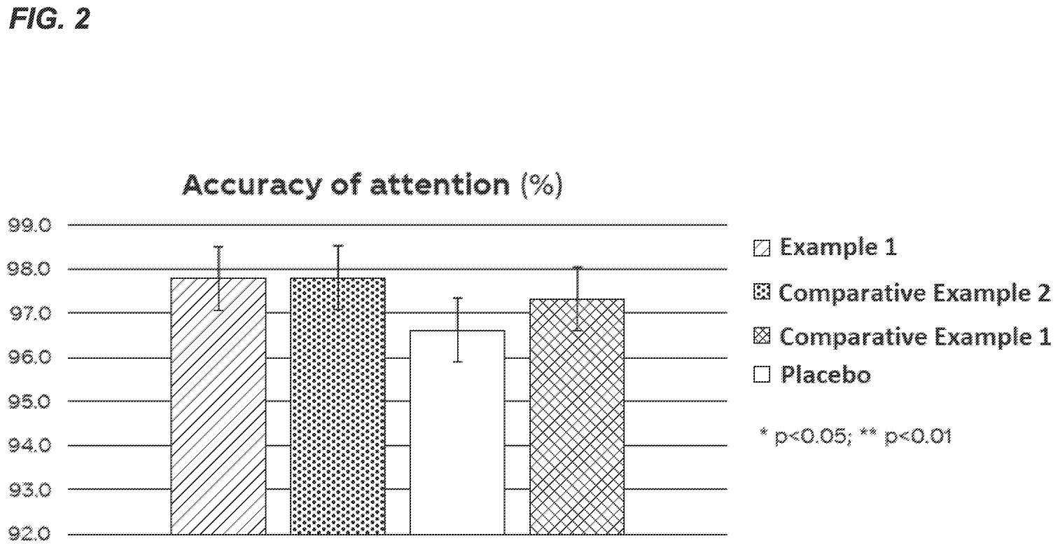

The results of composite accuracy of attention are shown in FIG. 2. As can be seen, both Example Beverage 1 (p=0.026) and Comparative Beverage 2 (p=0.022) significantly improved composite accuracy of attention comparing to placebo.

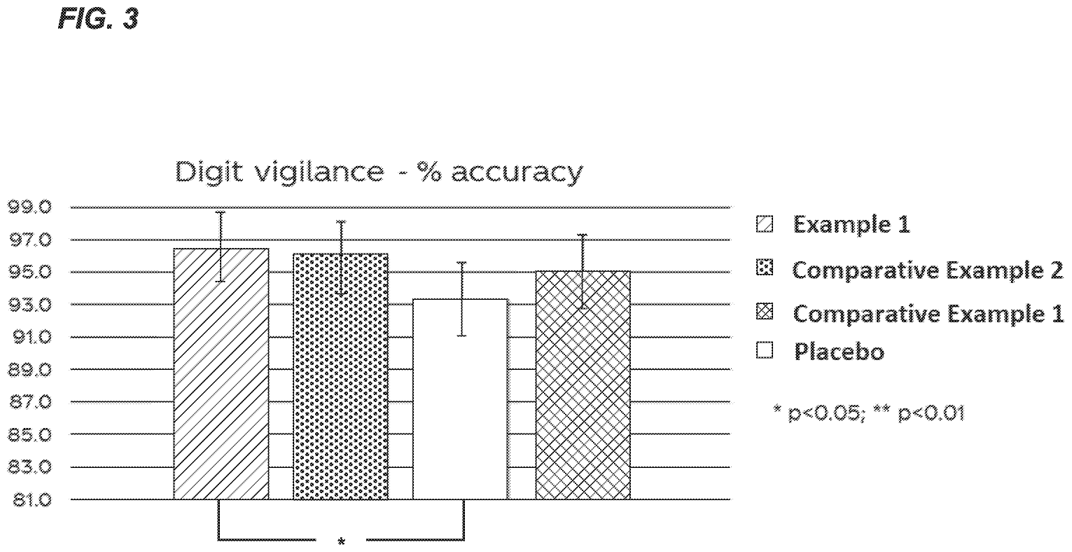

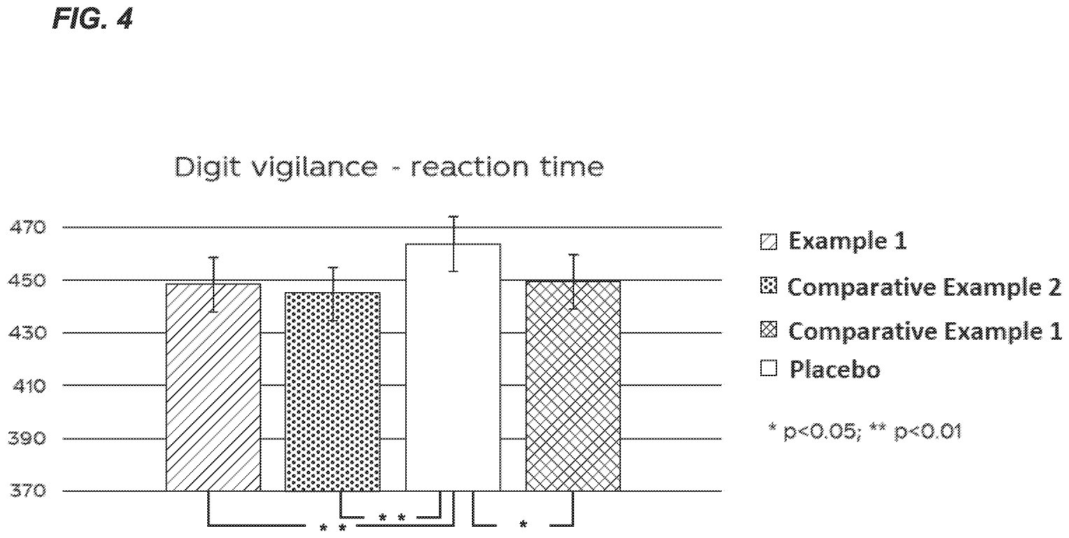

The results of digit vigilance test are shown in FIG. 3 (accuracy) and FIG. 4 (reaction time). As can be seen, Example Beverage 1 (coffee berry juice) significantly improved accuracy of digit vigilance (single task, as a sub-unit of attention) comparing to placebo (p=0.034), while no significance observed with respect to Comparative Beverages 1 and 2. As shown in FIG. 4, Example Beverage 1 showed significant improvement on the reaction time of digit vigilance comparing to the placebo.

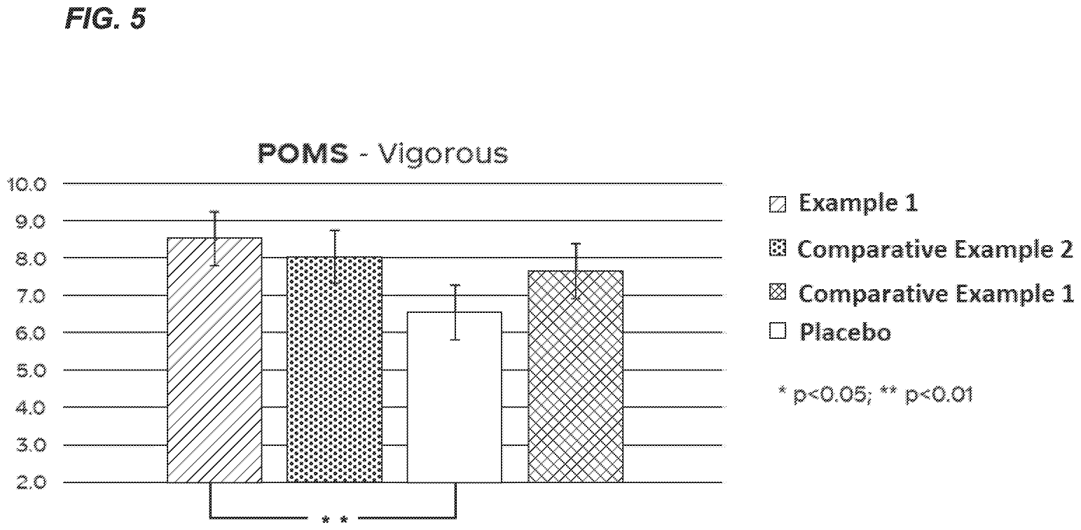

The results of Profile of Mood Scale (POMS) vigorous measurement are shown in FIG. 5. As can be seen, Example Beverage 1 (coffee berry juice) improved vigorous significantly compared to placebo (p=0.015); while neither Comparative Beverage 1 nor Comparative Beverage 2 showed improvement compared to placebo.

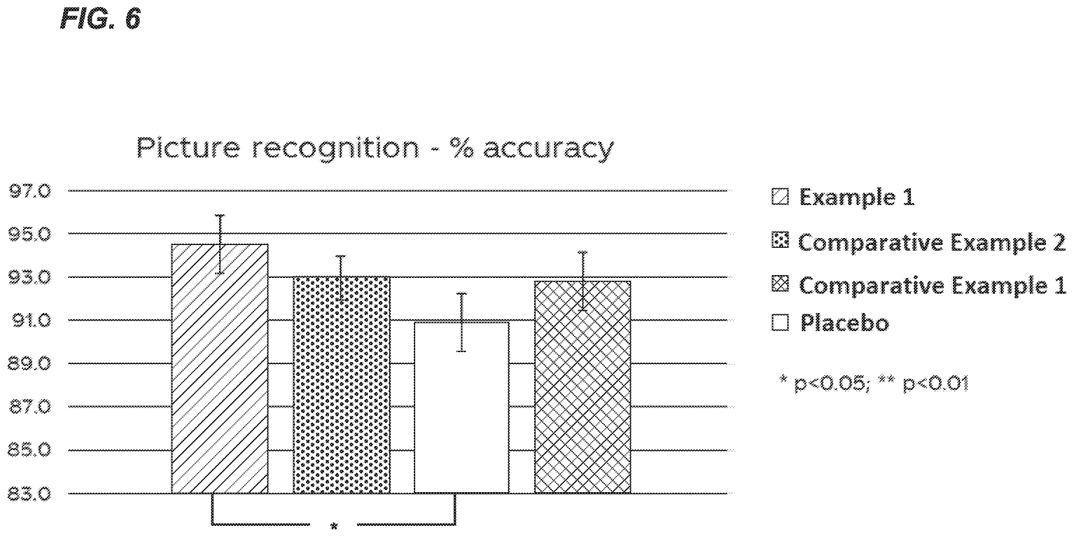

The results of picture recognition measurement are shown in FIG. 6. As can be seen, Example Beverage 1 (coffee berry juice) significantly improved the accuracy of picture recognition comparing to placebo (p=0.036). Example Beverage 1 was also found to have better performance than Comparative Beverage 1 and Comparative Beverage 2.

The above results provide evidence to support that caffeine and phenolic acids such as chlorogenic acids when administered in combination with an optimal ratio and dosage have synergistic effect on improving the cognitive function and alertness of a subject.

All of the compositions and methods disclosed and claimed herein can be made and executed without undue experimentation in light of the present disclosure. While the compositions and methods of this disclosure have been described in terms of the foregoing illustrative embodiments, it will be apparent to those of skill in the art that variations, changes, modifications, and alterations may be applied to the composition, methods, and in the steps or in the sequence of steps of the methods described herein, without departing from the true concept, spirit, and scope of the disclosure. More specifically, it will be apparent that certain agents, additives, and ingredients that are similar according to their physical, chemical, physiological, and/or gustative properties may be substituted for the agents, additives and ingredients described herein while the same or similar results would be achieved. All such similar substitutes and modifications apparent to those skilled in the art are deemed to be within the spirit, scope, and concept of the disclosure as defined by the hereinafter appended claims.

The following numbered clauses define further example aspects and features of the present disclosure:
1. An edible composition, comprising:
   caffeine and/or a derivative thereof; and
   a polyphenol,
   wherein the composition has a weight ratio of the total polyphenol to the total caffeine from about 1:10 to about 10:1.
2. The composition of clause 1, wherein the polyphenol is selected from the group of flavonoids, flavanols, flavones, isoflavones, flavanones, anthocyanins, phenolic acids, catechins, proanthocyanidins, procyanidins, quercetin, rutin, resveratrol, isoflavones, punicalagin, ellagitannin, hesperidin, naringin, citrus flavonoids, lignans, curcuminoids, stilbenes, an oligomeric/polymeric form thereof, or any combinations thereof.
3. The composition of clause 2, wherein the polyphenol comprises a chlorogenic acid selected from the group of caffeoylquinic acids, dicaffeoylquinic acids, feruloylquinic acids, cumaroylquinic acids, or a derivative thereof, or any combinations thereof.
4. The composition of any of clauses 1-3, further comprising a sweetener.
5. The composition of clause 4, wherein the sweetener is selected from the group comprising stevia and steviol glycosides, Luo Han Guo and the related mogroside compounds, monatin and its salts (monatin SS, RR, RS, SR), curculin, glycyrrhizic acid and its salts, thaumatin, monellin, mabinlin, brazzein, hemandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I, sugar alcohols such as erythritol, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs), and
6. The composition of any of clauses 1-5, further comprising at least one additive.
7. The composition of any of clauses 1-6, further comprising at least one functional ingredient.
8. The composition of any of clauses 1-7, wherein the composition is in a drinkable liquid form, a concentrate form, a dry form, or a semi-dry form.
9. The composition of any of clauses 1-8, wherein the composition is a gum, gel, tablet, capsule, granule, cubic, or dry powder.
10. The composition of any of clauses 1-9, wherein the composition is a beverage selected from the group of non-carbonated beverage, carbonated beverage, juice beverage, fruit juice, coffee beverage, tea beverage, milk beverage, diary beverage, plant protein drink, plant-based beverage, sport drink, energy drink.
11. The composition of any of clauses 1-10, wherein the composition has a Brix value of about 3° to about 25°, or about 5° to about 20°, or about 7° to about 15°.
12. The composition of any of clauses 1-11, further comprising a coffee product selected from the group of: coffee extract, concentrated coffee, dried coffee, soluble coffee, coffee oils, coffee aromas, dry green coffee extract, wet green coffee extract, pulverized coffee, ground coffee, roast coffee, roast and ground coffee, soluble coffee, or any combinations thereof.
13. The composition of any of clauses 1-12, further comprising a tea product selected from the group of: soluble tea product, tea extract, concentrated tea, dried tea, tea leaves, tea aromas, green tea extract, concentrated green tea extract, or any combinations thereof.
14. The composition of any of clauses 1-13, further comprising a coffee berry juice, or a coffee berry extract, or a product of coffee berry, or any combinations thereof.
15. The composition of clause 14, wherein the coffee berry juice and/or the coffee berry extract is derived from a whole coffee berry.
16. The composition of any of clauses 14-15, wherein the coffee berry juice is a non-concentrate coffee berry juice.
17. The composition of any of clauses 14-15, wherein the coffee berry juice is a from-concentrate coffee berry juice.
18. The composition of any of clauses 14-17, wherein the coffee berry is selected from the group of Coffea Arabica or derivative thereof, Coffea canephora or derivative thereof, or any combination thereof.
19. The composition of any of clauses 1-18, further comprising a yerba mate or a part or an extract or a product thereof.
20. The composition of any of clauses 1-19, wherein the composition has a total content of caffeine from about 0.01 wt % to about 2 wt %, or from about 0.05 wt % to about 1 wt %, or from about 0.1 wt % to about 0.5 wt %.
21. The composition of any of clauses 1-20, wherein the composition has a dosage of caffeine from about 10 mg to about 500 mg, or from about 20 mg to about 400 mg, or from about 30 mg to about 300 mg, or from about 40 mg to about 200 mg, or from about 50 mg to about 180 mg, or from about 60 mg to about 160 mg, or from about 70 mg to about 140 mg, or from about 80 mg to about 120 mg, or from about 90 mg to about 100 mg.
22. The composition of any of clauses 1-21, wherein the composition has a total content of polyphenol from about 0.01 wt % to about 2 wt %, or from about 0.05 wt % to about 1 wt %, or from about 0.1 wt % to about 0.5 wt %.
23. The composition of any of clauses 1-22, wherein the composition has dosage of polyphenol from 15 mg to about 300 mg, or from about 30 mg to about 200 mg, or from about 45 mg to about 150 mg for one serving.
24. The composition of any of clauses 1-23, wherein the weight ratio of the total polyphenol to the total caffeine is from about 1:8 to about 8:1, or from about 1:6 to about 6:1, or from about 1:4 to about 4:1, or from about 1:2 to about 2:1.
25. The composition of any of clauses 1-24, wherein the weight ratio of the total polyphenol to the total caffeine is from about 1.5:1 to about 3:1.
26. The composition of any of clauses 1-25, wherein the caffeine and/or the polyphenol is derived from a natural resource, wherein the natural resource is a plant selected from the group of coffee, tea, yerba mate, guayusa, yaupon, guarana, cocoa, kola, or any combination thereof.
27. The composition of any of clauses 1-26, wherein the composition comprises a coffee berry extract or a coffee berry juice, and wherein the polyphenol and/or the caffeine are all or substantially from the coffee berry extract or the coffee berry juice.
28. The composition of any of clauses 1-27, wherein the composition comprises a coffee berry extract or a coffee berry juice, and wherein at least a portion of the polyphenol and/or at least a portion of the caffeine is not from the extract of coffee nor the coffee berry juice.
29. The composition of any of clauses 1-28, wherein the composition is a manufactured food product.
30. A beverage comprising:
   caffeine and/or a derivative thereof; and
   a polyphenol comprising a chlorogenic acid and/or a derivative thereof,
   wherein the beverage has a weight ratio of the total chlorogenic acid to the total caffeine from about 1:10 to about 10:1.
31. The beverage of clause 30, wherein the chlorogenic acid is selected from the group of caffeoylquinic acids, dicaffeoylquinic acids, feruloylquinic acids, cumaroylquinic acids, or any combinations thereof.
32. The beverage of any of clauses 30-31, further comprising a coffee product selected from the group of: coffee extract, concentrated coffee, dried coffee, soluble coffee, coffee oils, coffee aromas, dry green coffee extract, wet green coffee extract, pulverized coffee, ground coffee, roast coffee, roast and ground coffee, soluble coffee, or any combinations thereof.
33. The beverage of any of clauses 30-32, further comprising a coffee berry juice.
34. The beverage of any of clauses 30-33, wherein the beverage has a total content of caffeine from about 0.01 wt % to about 0.1 wt %, or from about 0.02 wt % to about 0.8 wt %, from about 0.03 wt % to about 0.6 wt.
35. The beverage of any of clauses 30-34, wherein the beverage has a total content of chlorogenic acid from about 0.01 wt % to about 2 wt %, or from about 0.05 wt % to about 1 wt %, or from about 0.1 wt % to about 0.5 wt %.
36. The beverage of any of clauses 30-35, wherein the caffeine and the chlorogenic acid are derived from a coffee berry juice.
37. A beverage comprising a coffee berry juice, wherein the coffee berry juice
   caffeine; and
   a polyphenol comprising a chlorogenic acid,
   wherein the coffee berry juice has a weight ratio of the chlorogenic acid to the caffeine from about 1:10 to about 10:1.
38. The beverage of clause 37, consisting essentially of the coffee berry juice.
39. The beverage of any of clauses 37-38, wherein the chlorogenic acid is selected from the group of caffeoylquinic acids, dicaffeoylquinic acids, feruloylquinic acids, cumaroylquinic acids, or a derivative thereof, or any combinations thereof.
40. The beverage of any of clauses 37-39, wherein the beverage has a total content of caffeine from about 0.01 wt % to about 0.1 wt %, or from about 0.02 wt % to about 0.08 wt %, or from about 0.03 wt % to about 0.06 wt.
41. The beverage of any of clauses 37-40, wherein the beverage has a total content of chlorogenic acid from about 0.01 wt % to about 2 wt %, or from about 0.05 wt % to about 1 wt %, or from about 0.1 wt % to about 0.5 wt %.
42. The beverage of any of clauses 37-41, wherein the weight ratio of the total chlorogenic acid to the total caffeine is from about 1:8 to about 8:1, or from about 1:6 to about 6:1, or from about 1:4 to about 4:1, or from about 1:2 to about 2:1.
43. A beverage consisting of a coffee berry juice, the coffee berry juice comprising:
   from about 0.01 wt % to about 2 wt % of caffeine; and
   from about 0.01 wt % to about 2 wt % of a polyphenol, wherein the polyphenol is chlorogenic acid,
   wherein the coffee berry juice has a weight ratio of the chlorogenic acid to the caffeine from about 1:10 to about 10:1, or from about 1:8 to about 8:1, or from about 1:6 to about 6:1, or from about 1:4 to about 4:1, or from about 1:2 to about 2:1, or from about 1.5:1 to about 3:1.
44. The coffee berry juice of clause 43, being derived from a whole coffee berry.
45. The coffee berry juice of any of clauses 43-44, wherein the coffee berry juice is a non-concentrate coffee berry juice.
46. The coffee berry juice of any of clauses 43-45, wherein the coffee berry is selected from the group of Coffea Arabica or derivative thereof, Coffea canephora or derivative thereof, or any combination thereof.
47. The composition or beverage of any of clauses 1-46, wherein administration of the composition or beverage to a human causes one or more effects on the human: improving cognitive function; reducing mental fatigue, improving alertness, reducing stress, improving tranquility, improving alertness, improving mental capability, improving memory capability, improving memory accuracy, improving mood, improving relaxation, reducing headache, improving/sustaining attention, improving sports performance, or any combinations thereof.
48. The composition or beverage of any of clauses 1-47, wherein the composition takes effect after a time period following the administration, wherein the time period is about 5 minutes, or about 15 minutes, or about 30 minutes, or about 60 minutes, or about 90 minutes, or about 120 minutes.
49. The composition or beverage of any of clauses 1-48, wherein the composition or beverage administered to the human comprises at least about 50 mg, at least about 75 mg, at least about 100 mg, or at least about 125 mg of caffeine.
50. The composition or beverage of any of clauses 1-49, wherein the composition or beverage administered to the human comprises at least about 25 mg, at least about 50 mg, or at least about 75 mg, at least about 100 mg, or at least about 125 mg of polyphenol.
51. A method for improving a condition of a human, the method comprising:
   administering to the human in need of an improved condition an edible composition, wherein the composition comprises:
   caffeine and/or a derivative thereof; and
   a polyphenol,
   wherein the composition has a weight ratio of the total polyphenol to the total caffeine from about 1:10 to about 10:1.
52. The method of clause 51, wherein the polyphenol is selected from the group of flavonoids, flavanols, flavones, isoflavones, flavanones, anthocyanins, phenolic acids, catechins, proanthocyanidins, procyanidins, quercetin, rutin, resveratrol, isoflavones, punicalagin, ellagitannin, hesperidin, naringin, citrus flavonoids, lignans, curcuminoids, stilbenes, an oligomeric/polymeric form thereof, or any combinations thereof.
53. The method of any of clauses 51-52, wherein the polyphenol comprises a chlorogenic acid selected from the group of caffeoylquinic acids, dicaffeoylquinic acids, feruloylquinic acids, cumaroylquinic acids, or a derivative thereof, or any combinations thereof.
54. The method of any of clause 51-53, wherein the composition further comprises a sweetener.
55. The method of clause 54, wherein the sweetener is selected from the group comprising stevia and steviol glycosides, Luo Han Guo and the related mogroside compounds, monatin and its salts (monatin SS, RR, RS, SR), curculin, glycyrrhizic acid and its salts, thaumatin, monellin, mabinlin, brazzein, hemandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I, sugar alcohols such as erythritol, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs), and combinations thereof.
56. The method of any of clauses 51-55, wherein the composition further comprises at least one additive.
57. The method of any of clauses 51-56, wherein the composition further comprises at least one functional ingredient.
58. The method of any of clauses 51-57, wherein the composition is in a drinkable liquid form, a concentrate form, a dry form, or a semi-dry form.
59. The method of any of clauses 51-58, wherein the composition is a gum, gel, tablet, capsule, granule, cubic, or dry powder.
60. The method of any of clauses 51-59, wherein the composition is a beverage selected from the group of non-carbonated beverage, carbonated beverage, juice beverage, fruit juice, coffee beverage, tea beverage, milk beverage, diary beverage, plant protein drink, plant-based beverage, sport drink, energy drink.
61. The method of any of clauses 51-60, wherein the composition has a Brix value of about 3° to about 25°, or about 5° to about 20°, or about 7° to about 15°.
62. The method of any of clauses 51-61, wherein the composition further comprises a coffee product selected from the group of: coffee extract, concentrated coffee, dried coffee, soluble coffee, coffee oils, coffee aromas, dry green coffee extract, wet green coffee extract, pulverized coffee, ground coffee, roast coffee, roast and ground coffee, soluble coffee, or any combinations thereof.
63. The method of any of clauses 51-62, wherein the composition further comprises a tea product selected from the group of: soluble tea product, tea extract, concentrated tea, dried tea, tea leaves, tea aromas, green tea extract, concentrated green tea extract, or any combinations thereof.
64. The method of any of clauses 51-63, wherein the composition further comprises a coffee berry juice, or a coffee berry extract, or a product of coffee berry, or any combinations thereof.
65. The method of clause 64, wherein the coffee berry juice and/or the coffee berry extract is derived from a whole coffee berry.
66. The method of any of clauses 64-65, wherein the coffee berry juice is a non-concentrate coffee berry juice.
67. The method of any of clauses 64-65, wherein the coffee berry juice is a from-concentrate coffee berry juice.
68. The method of any of clauses 64-67, wherein the coffee berry is selected from the group of Coffea Arabica or derivative thereof, Coffea canephora or derivative thereof, or any combination thereof.
69. The method of any of clauses 51-68, wherein the composition further comprises a yerba mate or a part or an extract or a product thereof.
70. The method of any of clauses 51-69, wherein the composition has a total content of caffeine from about 0.01 wt % to about 2 wt %, or from about 0.05 wt % to about 1 wt %, or from about 0.1 wt % to about 0.5 wt %.
71. The method of any of clauses 51-70, wherein the composition has a dosage of caffeine from about 10 mg to about 500 mg, or from about 20 mg to about 400 mg, or from about 30 mg to about 300 mg, or from about 40 mg to about 200 mg, or from about 50 mg to about 180 mg, or from about 60 mg to about 160 mg, or from about 70 mg to about 140 mg, or from about 80 mg to about 120 mg, or from about 90 mg to about 100 mg.
72. The method of any of clauses 51-71, wherein the composition has a total content of polyphenol from about 0.01 wt % to about 2 wt %, or from about 0.05 wt % to about 1 wt %, or from about 0.1 wt % to about 0.5 wt %.
73. The method of any of clauses 51-72, wherein the composition has dosage of polyphenol from 15 mg to about 300 mg, or from about 30 mg to about 200 mg, or from about 45 mg to about 150 mg for one serving.
74. The method of any of clauses 51-73, wherein the weight ratio of the total polyphenol to the total caffeine is from about 1:8 to about 8:1, or from about 1:6 to about 6:1, or from about 1:4 to about 4:1, or from about 1:2 to about 2:1.
75. The method of any of clauses 51-74, wherein the weight ratio of the total polyphenol to the total caffeine is from about 1.5:1 to about 3:1.
76. The method of any of clauses 51-75, wherein the caffeine and/or the polyphenol is derived from a natural resource, wherein the natural resource is a plant selected from the group of coffee, tea, yerba mate, guayusa, vaupon, guarana, cocoa, kola, or any combination thereof.
77. The method of any of clauses 51-76, wherein the composition comprises a coffee berry extract or a coffee berry juice, and wherein the polyphenol and/or the caffeine are all or substantially from the coffee berry extract or a coffee berry juice.
78. The method of any of clauses 51-77, wherein the composition comprises a coffee berry extract or a coffee berry juice, and wherein at least a portion of the polyphenol and/or at least a portion of the caffeine is not from the extract of coffee nor the coffee berry juice.
79. The method of any of clauses 51-78, wherein the composition is a manufactured food product.
80. The method of any of clauses 51-79, wherein improving the condition of the human is selected from the group of: improving cognitive function; reducing mental fatigue, improving alertness, reducing stress, improving tranquility, improving alertness, improving mental capability, improving memory capability, improving memory accuracy, improving mood, improving relaxation, reducing headache, improving/sustaining attention, improving sports performance, or any combinations thereof.
81. The method of any of clauses 51-80, wherein the condition is improved after a time period following the administration, wherein the time period is at least about 5 minutes, or at least about 15 minutes, or at least about 30 minutes, or at least about 60 minutes, or at least about 90 minutes, or at least about 120 minutes.
82. The method of any of clauses 51-81, wherein the composition is administered to the human at one time.
83. The method of any of clauses 51-82, comprising administering the composition to the human one or more times a day.
84. The method of any of clauses 51-83, wherein the composition comprises at least about 50 mg, at least about 75 mg, at least about 100 mg, or at least about 125 mg of caffeine.
85. The method of any of clauses 51-84, wherein the composition comprises at least about 25 mg, at least about 50 mg, or at least about 75 mg, at least about 100 mg, or at least about 125 mg of polyphenol.
86. A method for improving a condition of a human, the method comprising:
   administering to the human in need of an improved condition a beverage, wherein the beverage comprises:
   caffeine and/or a derivative thereof; and
   a polyphenol comprising a chlorogenic acid and/or a derivative thereof,
   wherein the beverage has a weight ratio of the total chlorogenic acid to the total caffeine from about 1:10 to about 10:1.
87. The method of clause 86, wherein the chlorogenic acid is selected from the group of caffeoylquinic acids, dicaffeoylquinic acids, feruloylquinic acids, cumaroylquinic acids, or a derivative thereof, or any combinations thereof.
88. The method of any of clauses 86-87, wherein the beverage further comprises a coffee product selected from the group of: coffee extract, concentrated coffee, dried coffee, soluble coffee, coffee oils, coffee aromas, dry green coffee extract, wet green coffee extract, pulverized coffee, ground coffee, roast coffee, roast and ground coffee, soluble coffee, or any combinations thereof.
89. The method of any of clauses 86-88, wherein the beverage further comprises a coffee berry juice.
90. The method of any of clauses 86-89, wherein the beverage has a total content of caffeine from about 0.01 wt % to about 0.1 wt %, or from about 0.02 wt % to about 0.08 wt %, or from about 0.03 wt % to about 0.06 wt %.
91. The method of any of clauses 86-90, wherein the beverage has a total content of chlorogenic acid from about 0.01 wt % to about 2 wt %, or from about 0.05 wt % to about 1 wt %, or from about 0.1 wt % to about 0.5 wt %.
92. The method of any of clauses 86-91, wherein the caffeine and the chlorogenic acid are derived from a coffee berry juice.
93. A method for improving a condition of a human, the method comprising:
   administering to the human in need of an improved condition a beverage, wherein the beverage comprises a coffee berry juice, wherein the coffee berry juice
   caffeine; and
   a polyphenol comprising a chlorogenic acid,
   wherein the beverage has a weight ratio of the total chlorogenic acid to the total caffeine from about 1:10 to about 10:1.
94. The method of clause 93, wherein the beverage consists essentially of the coffee berry juice.
95. The beverage of any of clauses 93-94, wherein the chlorogenic acid is selected from the group of caffeoylquinic acids, dicaffeoylquinic acids, feruloylquinic acids, cumaroylquinic acids, or a derivative thereof, or any combinations thereof.
96. The beverage of any of clauses 93-95, wherein the beverage has a total content of caffeine from about 0.01 wt % to about 0.1 wt %, or from about 0.02 wt % to about 0.08 wt %, or from about 0.03 wt % to about 0.06 wt.
97. The beverage of any of clauses 93-96, wherein the beverage has a total content of chlorogenic acid from about 0.01 wt % to about 2 wt %, or from about 0.05 wt % to about 1 wt %, or from about 0.1 wt % to about 0.5 wt %.
98. The beverage of any of clauses 93-97, wherein the weight ratio of the total chlorogenic acid to the total caffeine is from about 1:8 to about 8:1, or from about 1:6 to about 6:1, or from about 1:4 to about 4:1, or from about 1:2 to about 2:1, or from about 1.5:1 to about 3:1.
99. A method for improving a condition of a human, the method comprising:
   administering to the human in need of an improved condition a beverage consisting of a coffee berry juice, wherein the coffee berry juice comprises:
   from about 0.01 wt % to about 2 wt % of caffeine; and
   from about 0.01 wt % to about 2 wt % of a polyphenol, wherein the polyphenol is a chlorogenic acid,
   wherein the coffee berry juice has a weight ratio of the chlorogenic acid to the caffeine from about 1:10 to about 10:1, or from about 1:8 to about 8:1, or from about 1:6 to about 6:1, or from about 1:4 to about 4:1, or from about 1:2 to about 2:1, or from about 1.5:1 to about 3:1.
100. The method of clause 99, wherein the coffee berry juice is derived from a whole coffee berry.
101. The method of any of clauses 99-100, wherein the coffee berry juice is a non-concentrate coffee berry juice.
102. The method of any of clauses 93-101, wherein the coffee berry is selected from the group of Coffea arabica or derivative thereof, Coffea canephora or derivative thereof, or any combination thereof.
103. The method of any of clauses 86-102, wherein improving the condition of the human is selected from the group of: improving cognitive function; reducing mental fatigue, improving alertness, reducing stress, improving tranquility, improving alertness, improving mental capability, improving memory capability, improving memory accuracy, improving mood, improving relaxation, reducing headache, improving/sustaining attention, improving sports performance, or any combinations thereof.
104. The method of any of clauses 86-103, wherein the condition is improved after a time period following the administration, wherein the time period is at least about 5 minutes, or at least about 15 minutes, or at least about 30 minutes, or at least about 60 minutes, or at least about 90 minutes, or at least about 120 minutes.
105. The method of any of clauses 86-104, wherein the beverage is administered to the human at one time.
106. The method of any of clauses 86-105, comprising administering the beverage to the human one or more times a day.
107. The method of any of clauses 86-106, wherein the beverage comprises at least about 50 mg, or at least about 75 mg, at least about 100 mg, at least about 125 mg of caffeine.
108. The method of any of clauses 86-107, wherein the beverage comprises at least about 25 mg, or at least about 50 mg, or at least about 75 mg, at least about 100 mg, at least about 125 mg of chlorogenic acid.

What is claimed is:

1. An edible composition, comprising:
caffeine and/or a derivative thereof; and
a polyphenol,
wherein the composition has a weight ratio of the total polyphenol to the total caffeine from about 1:10 to about 10:1.

2. The composition of claim 1, wherein the polyphenol is selected from the group of flavonoids, flavanols, flavones, isoflavones, flavanones, anthocyanins, phenolic acids, catechins, proanthocyanidins, procyanidins, quercetin, rutin, resveratrol, isoflavones, punicalagin, ellagitannin, hesperidin, naringin, citrus flavonoids, lignans, curcuminoids, stilbenes, an oligomeric/polymeric form thereof, or any combinations thereof.

3. The composition of claim 2, wherein the polyphenol comprises a chlorogenic acid selected from the group of caffeoylquinic acids, dicaffeoylquinic acids, feruloylquinic acids, cumaroylquinic acids, or a derivative thereof, or any combinations thereof.

4. The composition of any of claims 1-3, further comprising a sweetener.

5. The composition of claim 4, wherein the sweetener is selected from the group comprising stevia and steviol glycosides, Luo Han Guo and the related mogroside compounds, monatin and its salts (monatin SS, RR, RS, SR), curculin, glycyrrhizic acid and its salts, thaumatin, monellin, mabinlin, brazzein, hemandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I, sugar alcohols such as erythritol, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs), and combinations thereof.

6. The composition of any of claims 1-5, further comprising at least one additive.

7. The composition of any of claims 1-6, further comprising at least one functional ingredient.

8. The composition of any of claims 1-7, wherein the composition is in a drinkable liquid form, a concentrate form, a dry form, or a semi-dry form.

9. The composition of any of claims 1-8, wherein the composition is a gum, gel, tablet, capsule, granule, cubic, or dry powder.

10. The composition of any of claims 1-9, wherein the composition is a beverage selected from the group of non-carbonated beverage, carbonated beverage, juice beverage, fruit juice, coffee beverage, tea beverage, milk beverage, diary beverage, plant protein drink, plant-based beverage, sport drink, energy drink.

11. A beverage comprising:
caffeine and/or a derivative thereof; and
a polyphenol comprising a chlorogenic acid and/or a derivative thereof,
wherein the beverage has a weight ratio of the total chlorogenic acid to the total caffeine from about 1:10 to about 10:1.

12. A beverage comprising a coffee berry juice, wherein the coffee berry juice comprises:
caffeine; and
a polyphenol comprising a chlorogenic acid,
wherein the coffee berry juice has a weight ratio of the chlorogenic acid to the caffeine from about 1:10 to about 10:1.

13. A method for improving a condition of a human, the method comprising:
administering to the human in need of an improved condition an edible composition, wherein the composition comprises:
caffeine and/or a derivative thereof; and
a polyphenol,
wherein the composition has a weight ratio of the total polyphenol to the total caffeine from about 1:10 to about 10:1.

14. The method of claim 13, wherein the polyphenol is selected from the group of flavonoids, flavanols, flavones, isoflavones, flavanones, anthocyanins, phenolic acids, catechins, proanthocyanidins, procyanidins, quercetin, rutin, resveratrol, isoflavones, punicalagin, ellagitannin, hesperidin, naringin, citrus flavonoids, lignans, curcuminoids, stilbenes, an oligomeric/polymeric form thereof, or any combinations thereof.

15. The method of any one of claim 13 or 14, wherein the polyphenol comprises a chlorogenic acid selected from the group of caffeoylquinic acids, dicaffeoylquinic acids, feruloylquinic acids, cumaroylquinic acids, or a derivative thereof, or any combinations thereof.

16. The method of any one of claims 13-15, wherein the composition further comprises a sweetener.

17. The method of claim 16, wherein the sweetener is selected from the group comprising stevia and steviol glycosides, Luo Han Guo and the related mogroside compounds, monatin and its salts (monatin SS, RR, RS, SR), curculin, glycyrrhizic acid and its salts, thaumatin, monellin, mabinlin, brazzein, hemandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I, sugar alcohols such as erythritol, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs), and combinations thereof.

18. The method of any one of claims 13-17, wherein the composition further comprises at least one additive.

19. The method of any one of claims 13-18, wherein the composition further comprises at least one functional ingredient.

20. The method of any one of claims 13-19, wherein the composition is in a drinkable liquid form, a concentrate form, a dry form, or a semi-dry form.
